(19) United States
(12) Patent Application Publication
(10) Pub. No.: US 2003/0041019 A1
(43) Pub. Date: Feb. 27, 2003

(54) Methods and systems for deal structuring for automobile dealers

(76) Inventors: James G. Vagim III, Atadena, CA (US); Michael Duke, Los Angeles, CA (US); Kenton D. Hagan, Marina del Rey, CA (US); Bruce E. Newmark, West Covina, CA (US)

Correspondence Address: CHRISTIE, PARKER & HALE, LLP, 350 WEST COLORADO BOULEVARD, SUITE 500, PASADENA, CA, 91105, US

(21) Appl. No.: 10/043,676

(22) Filed: Jan. 9, 2002

Related U.S. Application Data
(60) Provisional application No. 60/312,923, filed on Aug. 15, 2001.

(51) Int. Cl. G06F 17/60

(52) U.S. Cl. 705/38

(57) ABSTRACT

A method for deal structuring by a dealer, using a network based system including a server system coupled to a centralized database and at least one client system is disclosed. The method comprises receiving a loan application from a buyer regarding the deal, running a credit report based on the loan application, analyzing and scoring the credit report to evaluate the buyer's creditworthiness in relationship to the deal, and structuring the deal based on the buyer's creditworthiness. In an exemplary embodiment, the method provides guidance to the dealer utilizing a cartoon character based on pre-determined credit criteria to adjust various parameters to successfully structure the deal.

### CROSS REFERENCE TO RELATED APPLICATIONS

This patent application claims the benefit of the filing date of U.S. Provisional Application No. 60/312,923, filed Aug. 15, 2001, and ENTITLED METHODS AND SYSTEMS FOR DEAL STRUCTURING FOR AUTOMOBILE DEALERS, the entire contents of which are hereby incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to deal structuring and more particularly to processing and approving loans for automobile dealers on behalf of their buyers.

The sub-prime auto finance industry refers to lenders who specialize in financing loans for dealers that sell used cars. Because of the lower margins and increased competition in the sub-prime auto finance industry, innovation and creativity are a necessity to improve efficiency and operational profitability. A business entity that specializes in sub-prime auto finance area must deal with various dealers across the country to process and approve the loans.

Traditionally, after a buyer selects a used car from a used car dealership, the buyer completes the loan application package to finance the loan. The used car dealer reviews the loan application, runs the credit report of the buyer and forwards the loan application to the lender. Once the lender receives the loan application, the lender processes the loan application. The processing of the loan application usually takes three to four days depending on the lender's turnaround time and the funding criteria for used cars. A large number of loan applications are processed either by traditional banks or sub-prime lenders specializing in processing loans for used car dealers in compliance with various state and federal regulations. The used car dealer does not know the decision of the lender for several days. During this entire process, the car dealer cannot deliver the car to the buyer because of uncertainty associated with the financing. Once the buyer leaves the dealer's premises, the buyer may change his mind, thereby causing the loss of business. Additionally, the process of getting the application filled out, running a credit check, and verifying other supporting documents requires a certain level of competence, training, and resources, which are often hard to find and retain.

In view of the above, it would be desirable to have systems and methods that streamline the process by providing an instantaneous loan approval decision to the dealer based on pre-determined credit guidelines thereby providing the dealer an opportunity to deliver the car immediately.

### BRIEF SUMMARY OF THE INVENTION

In an exemplary embodiment, the invention is an integrated network based system, which organizes a business entity's experiences, operating procedures, best practices, information sources, credit guidelines, and analytical tools on a server for easy storage and retrieval. The invention is a method and a system to manage automobile loans and to provide status of the automobile loans to all involved parties including, but not limited to, dealers and the business entity on an on-going basis. The information provided over the web is real time information and any newly added information is updated and processed on a continuous basis. The objective is to increase the profitability of the business entity in dealer financing by streamlining the deal structuring process.

The Deal Structuring System (DSS), a fully integrated on-line web-based system, is a company-wide communication tool. The DSS is a centralized and integrated business tool created to drive business accountability and performance, and to improve closing of the deals in a timely manner. It enhances lines of communication between the dealers at various locations and the business entity to close the deal. The DSS utilizes the Internet to increase communication. The DSS not only makes the deal structuring process more accessible but it also makes the lending process faster, more reliable, efficient and profitable, while offering a wider variety of deal structuring options to the dealer. The DSS is secure, exclusive and protected.

The DSS is designed to facilitate dealer participation and to improve the dealer's efficiency in structuring as well as closing the deal. The business entity provides the processing know-how to offer the best available loan and a streamlined approval process to benefit the dealer's customers while paying the dealer the discounting on rates in full compliance with local, state and federal rules and regulations.

In an exemplary embodiment, the invention provides a method for deal structuring by a dealer. The method utilizes a network-based system including a server system coupled to a centralized database and at least one client system. The method comprises the steps of receiving a loan application from a buyer regarding the deal, running a credit report based on the loan application, analyzing the credit report to evaluate the buyer's creditworthiness in relation to the deal, and structuring the deal based on the buyer's creditworthiness. In an exemplary embodiment, the method further comprises reviewing the loan application and the credit report of the buyer, auditing underlying documents in compliance with legal guidelines for funding the deal, and issuing a check to the dealer pursuant to legal agreements to fund the deal.

The step of structuring the deal further comprises the steps of adjusting the deal and providing the guidance to the dealer utilizing a cartoon character. The deal is adjusted based on the down payment, the price of the deal, the term of the deal, the amount financed, the class of the car, or the dealer discount.

In another exemplary embodiment, the invention provides a system to implement the process for structuring various deals in compliance with state and federal regulations. The system includes a computer, and at least one server connected via a network to the computer. The system is configured to provide access to a dealer after the dealer has been authenticated. The system is further configured to run a credit report on a buyer based on the buyer's loan application, receive additional information from the dealer about the deal after the buyer's information has been automatically transferred to a deal structure user interface, and approve the deal based on a pre-determined credit criteria. If the deal cannot be approved, the system provides guidance to the dealer, utilizing a cartoon character, based on the pre-determined credit criteria to adjust the deal structure parameters.

In yet another exemplary embodiment, the invention provides a computer to facilitate online processing and approval of deals. The computer is programmed to receive deal information into the centralized database, store the deal information into various subsections of the centralized database, and cross reference the deal information against a dealer identification for easy retrieval and update. The computer is further programmed to evaluate the deal based on pre-determined credit criteria, provide guidance to the dealer to adjust the deal based on pre-determined underwriting criteria, and approve the deal after the dealer has made changes based on the provided guidance. The computer is also programmed to generate management reports to track the deal status and to download a home page user interface, credit report user interface, a customer information user interface, deal calculation user interface and a deal structure user interface.

In yet further exemplary embodiment, a computer program embodied on a computer readable medium is provided. The computer program comprises a code segment that receives a deal from the dealer, evaluates the deal based on pre-defined risk guidelines, and provides a decision to the dealer of at least one of approving and rejecting the deal after the underlying documents are audited to ensure compliance with state and federal regulations. The computer program evaluates the deal utilizing at least one of a term, an advance, and a discount. The term is determined by evaluating the year of the vehicle, mileage, and the Class combined with the Customer Factor, while the advance allowed is determined by at least one of a Wholesale Kelley Bluebook value, the NADA Trade Value, mileage, and the Class of the vehicle. The discount is determined by utilizing a Payment Probability Model, a Minimum Discount Model to determine minimum discounts for certain sets of input, or an Extra Term Model. The computer program further includes a code segment that monitors the security by restricting access to unauthorized individuals.

In yet another exemplary embodiment, a centralized database to organize deal structuring is disclosed. The database comprises data corresponding to at least one of Dealers Information, Vehicle Information, Dealer Transactions, Buyers Information, and Credit Guidelines, wherein the data corresponding to at least one of Dealers Information and Dealer Transactions is cross referenced to data corresponding to Buyers Information.

In yet further exemplary embodiment, a method for structuring a deal by a dealer for a buyer is provided. The method utilizes a network based system including a server system, a centralized database and a client system. The method comprises accepting deal data from the client system, running a credit report based on the pre-determined credit guidelines, and providing the response to the dealer based on the deal data and the buyer's credit worthiness. The method further allows the dealer to structure the deal successfully based on the response and the guidance received from the server system. The method further comprises the steps of providing a response that includes at least one of a YES/YES, a YES/NO, a NO/YES, and a NO/NO response, and then providing the guidance to the dealer utilizing a cartoon character to successfully structure the deal. The response YES/YES refers to an approval of the deal structured and an approval of amount financed by the dealer, while the response NO/NO refers to a rejection of the deal structured and a rejection of amount financed by the dealer.

### BRIEF DESCRIPTION OF THE DRAWINGS

FIG. 1 is a flow chart of a Deal Process between a dealer and a lender;

FIG. 2 is a block diagram of a Deal Structuring System (DSS);

FIG. 3 is an expanded version block diagram of an exemplary embodiment of a server architecture of the DSS;

FIG. 4 illustrates a configuration of a database within a database server of the server system shown in FIG. 2;

FIG. 5 is an exemplary embodiment of a hardware architecture diagram of a general purpose computer suitable for use as a server host;

FIG. 6 is an exemplary embodiment of a flow chart of a deal structuring process;

FIG. 7 is an exemplary embodiment of a deal structure user interface;

FIG. 8 is an exemplary embodiment of a first page of a dealer contact check list;

FIG. 9 is an exemplary embodiment of a second page of the dealer contract check list,

FIG. 10 is an exemplary embodiment of a first page of a reference list;

FIG. 11 is an exemplary embodiment of a second page of the reference list;

FIG. 12 is an exemplary embodiment of a due diligence process;

FIG. 13 is an exemplary embodiment of logical process components pertaining to overall disposition to purchase;

FIG. 14 is an exemplary embodiment of data flow diagrams of the DSS depicting the functionality of the system;

FIG. 15 is an exemplary embodiment of a home page user interface welcoming the user to the business entity's web site;

FIG. 16 is an exemplary embodiment of a user interface providing the information to the user regarding a specific loan transaction;

FIG. 17 is an exemplary embodiment of a Credit Report user interface providing the information to the user regarding a specific buyer;

FIG. 18 is an exemplary embodiment of a Customer Information user interface providing the information to the user regarding the buyer's credit;

FIG. 19 is an exemplary embodiment of a Deal Calculation user interface providing the information to the user regarding the buyer's credit;

FIG. 20 is an exemplary embodiment of a Deal Calculation user interface indicating to the user that the deal is now approved;

FIG. 21 is yet another exemplary embodiment of the Deal Calculation user interface indicating to the user that the deal is now approved;

FIG. 22 is an exemplary embodiment of a Saved Deal user interface; and

FIG. 23 is an exemplary embodiment of a Deal Structure user interface with all of the parameters and bureau parsed information.

### DETAILED DESCRIPTION OF THE INVENTION

Exemplary embodiments of systems and processes that facilitate integrated network-based electronic reporting and workflow process management related to a Deal Structuring System (DSS) are described below in detail. The systems and processes facilitate, for example, electronic submission of information using a client system, automated extraction of information, and web-based processing, tracking and approval of real estate loans.

The systems and processes are not limited to the specific embodiments described herein. In addition, components of each system and each process can be practiced independent and separate from other components and processes described herein. Each component and process also can be used in combination with other components and processes.

In an exemplary embodiment, the application is implemented as a Centralized Database utilizing a Structured Query Language (SQL) with a client user interface front-end for administration and a web interface for standard user input and reports. The application is web enabled and runs on a business entity's intranet. In a further exemplary embodiment, the application is fully accessed by individuals having authorized access outside the firewall of the business entity through the Internet. In another exemplary embodiment, the application is run in a Windows NT environment or simply on a stand alone computer system. In yet another exemplary embodiment, the application is practiced through manual process steps. The application is flexible and designed to run in various different environments without compromising the major functionality.

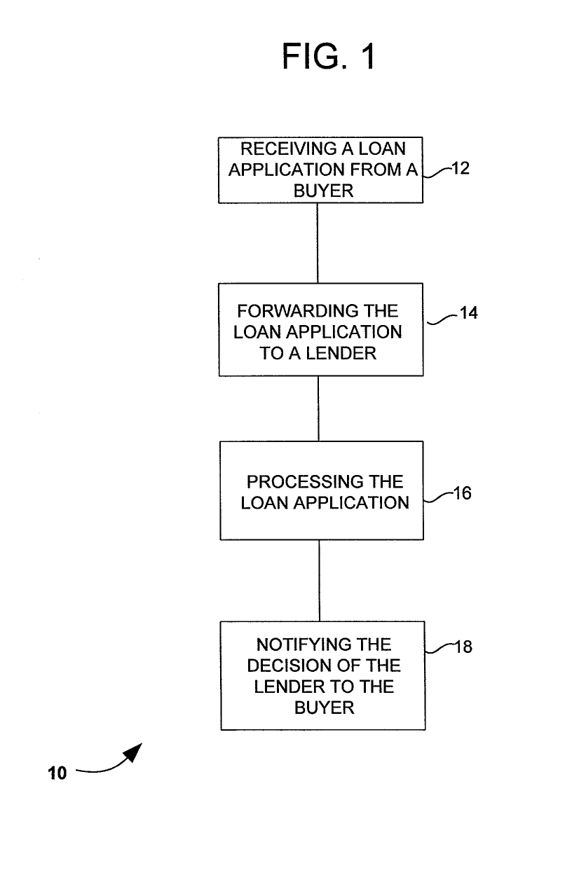

FIG. 1 is an exemplary embodiment of a flow chart of a deal process 10 between a dealer and a business entity, also referred to herein as a lender. In one embodiment, the deal refers to a purchase of a car from the car dealer and obtaining the financing by the car dealer on behalf of the buyer from a business entity/lender. The deal process for loan processing and approval utilizes a network based system, a centralized database and a client system.

In another embodiment, the deal process is practiced utilizing a computer program embodied on a computer readable medium installed on a stand alone computer. The computer program instructions implementing various steps including receiving loan information, processing the credit report, scoring the credit report, parsing credit report information onto a deal structure user interface, and structuring the deal are stored on the disk storage device until the microprocessor retrieves the computer program instructions and stores them in the main memory. The microprocessor then executes the computer program instructions stored in the main memory to help the dealer structure the deal.

The deal process includes receiving 12 a loan application from a buyer after the buyer has selected a car from the dealership. The process further includes forwarding 14 the loan application of the buyer to the lender. Once the loan application is received by the lender, the lender processes 16 the loan application by reviewing it, scoring it based on the buyer's credit rating, and approving or declining the loan application based on the lender's pre-selected criteria. The lender further notifies 18 the dealer of the loan decision which is communicated to the buyer. If the loan is approved, the buyer signs the loan documents and obtains the possession of the car. The dealer further processes the registration and other related documents in compliance with the laws, rules, and regulations of state agencies.

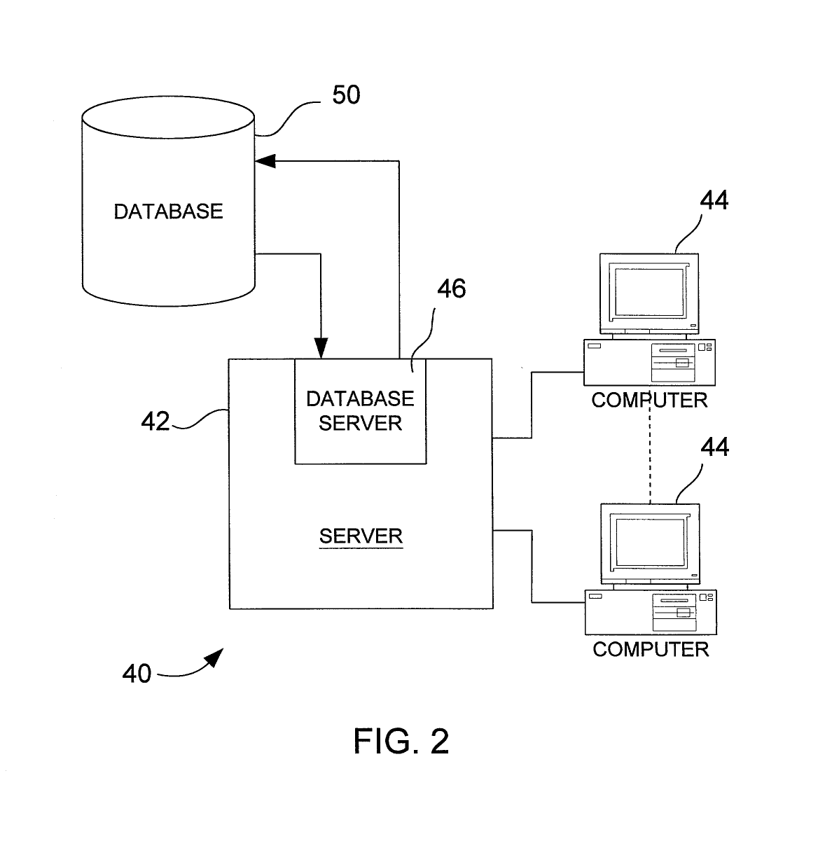

FIG. 2 is a block diagram of a DSS 40 that includes a server system 42, sometimes referred to herein as server 42, and a plurality of customer devices 46 connected to server 42. DSS 40 is implemented for processing and approval of various different types of loans. DSS 40 utilizes several pre-defined loan decision guidelines/criteria and checklists in performing the loan analysis. The loan decision criteria and checklists, and various other business tools and processes, as described below in more detail, are stored on server system 42 and can be accessed by the dealer at any one of customer devices 46.

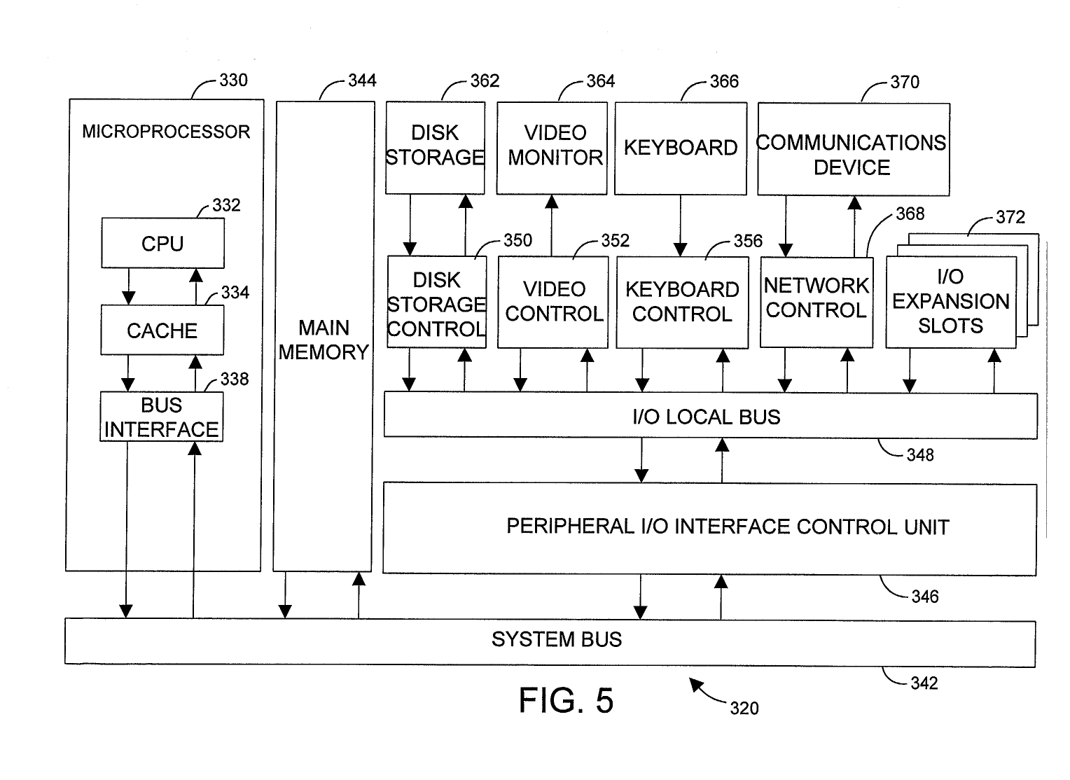

In one embodiment, devices 44 are general purpose computers including a web browser, and server 42 is accessible to devices 44 via a network such as an intranet or a wide area network such as the Internet. FIG. 5 below describes the general purpose computer 44 in detail. In an alternative embodiment, devices 44 are servers for a network of customer devices. Customer device 44 could also be any client system capable of interconnecting to the Internet including a web-based digital assistant, a web-based phone or other web-based connectable equipment. In another embodiment, server 42 is configured to accept information over a telephone, for example, at least one of a voice responsive system where a user enters spoken data, or by a menu system where a user enters a data request using the touch keys of a telephone, as prompted by server 42.

Devices 44 are interconnected to the network, such as a local area network (LAN) or a wide area network (WAN), through many interfaces including dial-in-connections, cable modems and high-speed lines. Server 42 includes a database server 46 connected to a centralized database 50. In one embodiment, centralized database 50 is stored on database server 46 and is accessed by potential customers at one of customer devices 44 by logging onto server system 42. In an alternative embodiment, centralized database 50 is stored remotely from server 42.

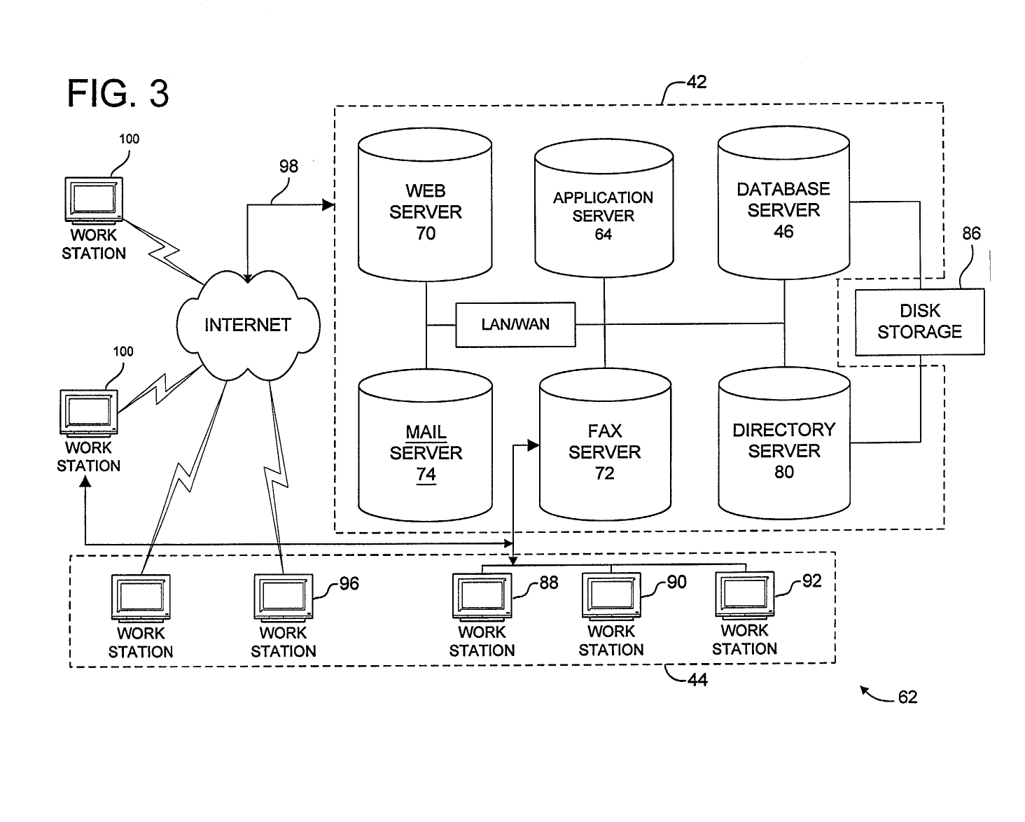

FIG. 3 is an expanded version block diagram of an exemplary embodiment of a server architecture of a DSS 62. DSS 62 is implemented for the complex environment. Components in DSS 62, identical to components of system 40 (shown in FIG. 2), are identified in FIG. 3 using the same reference numerals used in FIG. 2. DSS 62 includes server system 42 and customer devices 44. Server system 42 includes, but is not limited to, a database server 46, an application server 64, a web server 70, a fax server 72, a mail server 74 and a directory server 80.

Servers are often dedicated, meaning that they perform no other tasks besides their server tasks. For example, application server 64 serves various applications and modules associated with the computer program applications to users and also acts as a traffic officer in a database intensive application such as this. Web server 70 hosts the web site using one of the multi-platform servers. Fax server 72 sends and receives faxes with the Internet server. The fax server helps keep the costs low and saves paper. Directory server 80 manages various directories and sub directories to organize information. Mail server 74 sets up a messaging system that allows the users to exchange e-mails over LANs and/or the Internet. In yet another embodiment, there are other servers including, but not limited to, Audio/Video server to deliver streaming multi-media content, a List server to create and serve individualized mailing lists, e-mail response system for users, customer, or affiliates, and Chat servers are utilized.

A disk storage unit 84 is coupled to database server 46 and directory server 80. Servers 46, 64, 70, 72, 74, and 80 are coupled in a local area network (LAN) 82. Additionally, workstations 88, 90, and 92 are coupled to LAN 82. Alternatively, workstations 88, 90, and 92 are coupled to LAN 82 via an Internet link or are connected through an intranet. A system administrator, a loan processing clerk and a loan approval manager use workstations 88, 90, and 92, respectively.

Each workstation 88, 90, and 92 is a personal computer including a web browser. The business entity assigns workstations to different departments depending on their needs. Although the functions performed at the workstations typically are illustrated as being performed at respective workstations 88, 90, and 92, such functions can be performed at one of many personal computers coupled to LAN 82. Workstations 88, 90, and 92 are illustrated as being associated with separate functions only to facilitate an understanding of the different types of functions that can be performed by individuals having access to LAN 82.

Server system 42 is configured to be communicatively coupled to various individuals or employees and to third parties, e.g., a dealer 96 via an ISP Internet connection 98. The communication in the exemplary embodiment is illustrated as being performed via the Internet, however, any other wide area network (WAN) type communication can be utilized in other embodiments, i.e., the systems and processes are not limited to being practiced via the Internet. In addition, local area network 82 could be used in place of WAN 86.

In an exemplary embodiment, any employee of the business entity or a dealer 96 having a workstation can access server system 42. One of customer devices 44 includes workstations 100 located at a remote location. Workstations 100 are personal computers including a web browser. Also, workstations 100 are configured to communicate with server system 42. Furthermore, fax server 72 communicates with employees that are responsible for marketing/field assignments and dealers 96 located in various parts of the country and any of the remotely located systems, via a telephone link.

The systems described in FIGS. 2 and 3 are configured to implement a methodology to process and approve car loans in compliance with state and federal regulations with the aid of a dealer and to analyze loans based on pre-determined criteria and methodology established by the business entity based on risk factors and economic conditions.

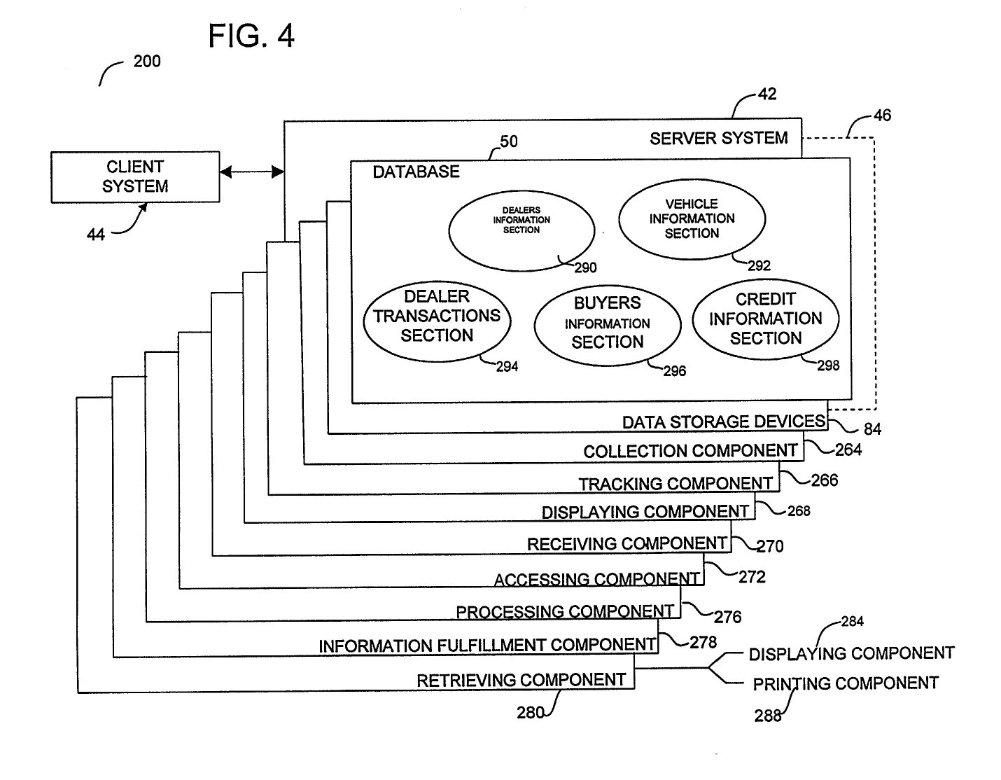

FIG. 4 shows a configuration 200 of database 50 within database server 46 of server system 42 (shown in FIG. 2). Components that are identical to components in FIGS. 2 and 3 are identified in FIG. 4 using the same reference numerals. Database 50 is coupled to several separate components within server system 42. These separate components perform specific tasks as required to achieve the system functionality.

Server system 42 includes a collection component 264 for collecting information from users into centralized database 50, a tracking component 266 for tracking information, a displaying component 268 to display information, a receiving component 270 to receive a specific query from client system 44, and an accessing component 272 to access centralized database 50. Receiving component 270 is programmed for receiving a specific query from one of a plurality of users. Server system 42 further includes a processing component 276 for searching and processing received queries against a data storage device 284 containing a variety of information collected by collection component 264. An information fulfillment component 278, located in server system 42, downloads the requested information to the plurality of users in the order in which the requests are received by receiving component 270. Information fulfillment component 278 downloads the information after the information is retrieved from data storage device 284 by a retrieving component 280. Retrieving component 280 retrieves, downloads and sends information to client system 44 based on a query received from client system 44 regarding various alternatives.

Retrieving component 280 further includes another display component 286 configured to download information to be displayed on a client system's graphical user interface and a printing component 288 configured to print information. Retrieving component 280 generates various reports requested by the user through client system 44 in a pre-determined format. System 40 has flexibility to provide alternative reports and is not constrained to the options set forth above.

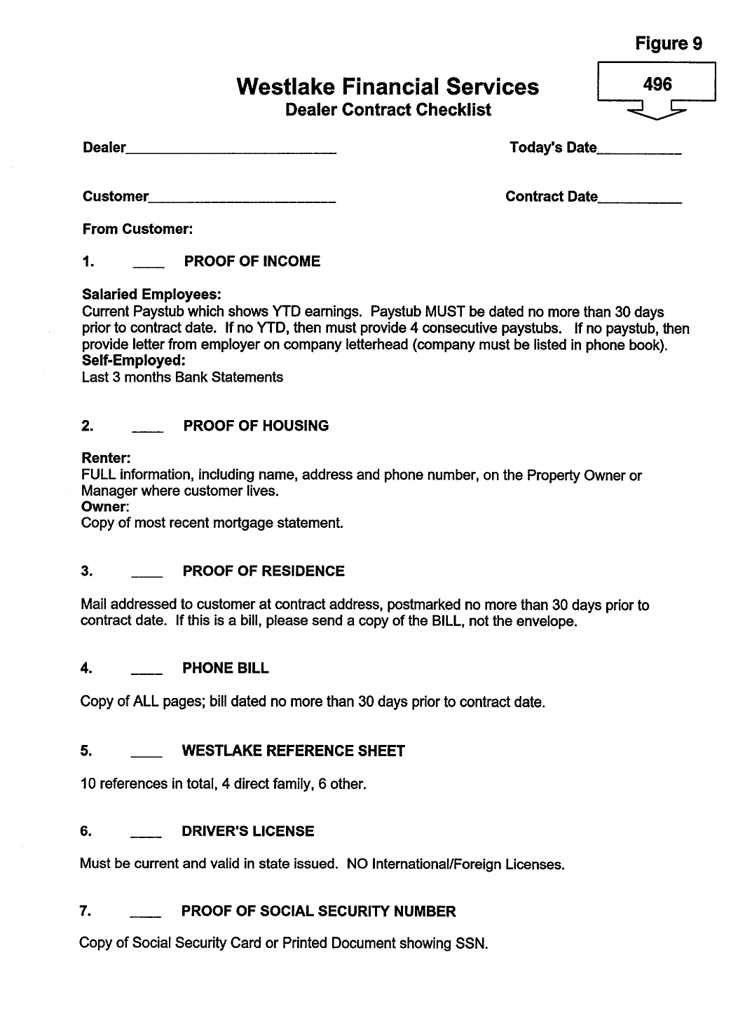

In an exemplary embodiment, database 50 is divided into a Dealer's Information Section (DIS) 290, a Vehicle Information Section (VIS) 292, a Dealer Transactions Section (DTS) 294, a Buyers Information Section (BIS) 296, and a Credit Guidelines Section (CGS) 298. For example, DIS 290 includes information about various dealers that are contracted to conduct business with the business entity. In an exemplary embodiment, DIS 290 includes information about approximately 3000 dealers across the United States. VIS 292 includes information about various vehicles, including, but not limited to, Class codes, whether the vehicle is an imported or a domestic manufactured vehicle, Kelley Blue Book value or NADA book value for each vehicle, and so on. DTS 294 includes information pertaining to various dealer transactions. BIS 296 includes information about various buyers that are conducting business with various dealers across the United States. BIS 296 also includes information on each buyer, buyer's contact information, and credit report information pertaining to each buyer. BIS 296 includes contact information as it relates to each buyer and each transaction. CGS 298 includes information on various credit guidelines established by the business entity and summarized hereunder in FIG. 9 below. Sections 290, 292, 294, 296 and 298 within database 50 are interconnected to update and retrieve the information as required. Each Section is further divided into several individualized sub-sections to store data in various different categories.

FIG. 5 is an exemplary embodiment of a hardware architecture 320 diagram of a general purpose computer suitable for use as a server host. A microprocessor 330, comprised of a Central Processing Unit (CPU) 332, a memory cache 334, and a bus interface 338, is operatively coupled via a system bus 342 to a main memory 344 and an I/O control unit 346. The I/O interface control unit is operatively coupled via an I/O local bus 348 to a disk storage controller 350, a video controller 352, a keyboard controller 356, and a communications device 360. The communications device is adapted to allow software objects hosted by the general purpose computer to communicate via a network with other software objects. Disk storage controller 350 is operatively coupled to a disk storage device 362. Video controller 352 is operatively coupled to a video monitor 364. Keyboard controller 356 is operatively coupled to a keyboard 366. A network controller 368 is operatively coupled to a communications device 370. The system has I/O expansion slots 372 to accommodate future upgrades.

Computer program instructions implementing loan processing and approval criteria are stored on the disk storage device until the microprocessor retrieves the computer program instructions and stores them in the main memory. The microprocessor then executes the computer program instructions stored in the main memory to implement the network based Deal Structuring System.

The architecture of system 40 as well as various components of system 40 are exemplary only. Other architectures are possible and can be utilized in connection with practicing the processes described below.

I. Overview of the Deal Structuring System

Deal Structuring System (DSS) 40, a fully integrated on-line web-based system, is a tool to facilitate communication with dealers across the United States. The DSS is a centralized and integrated business tool created to drive business accountability and performance, and to improve closing of the deals in a timely manner. It enhances lines of communication between the dealers at various locations and the business entity to close the deal. DSS 40 utilizes the Internet to improve communication. DSS 40 not only makes the deal structuring process more accessible but it also makes the lending process faster, more reliable, efficient and profitable, while offering a wider variety of deal structuring options to the dealer. DSS 40 is secure, exclusive and protected.

The DSS is designed to facilitate dealer participation and to improve dealer's efficiency in structuring and closing the deal. The business entity provides the processing know-how to structure the deal and a streamlined electronic approval to benefit the dealer's customers.

II. Flow Diagram Depicting Deal Structuring Process

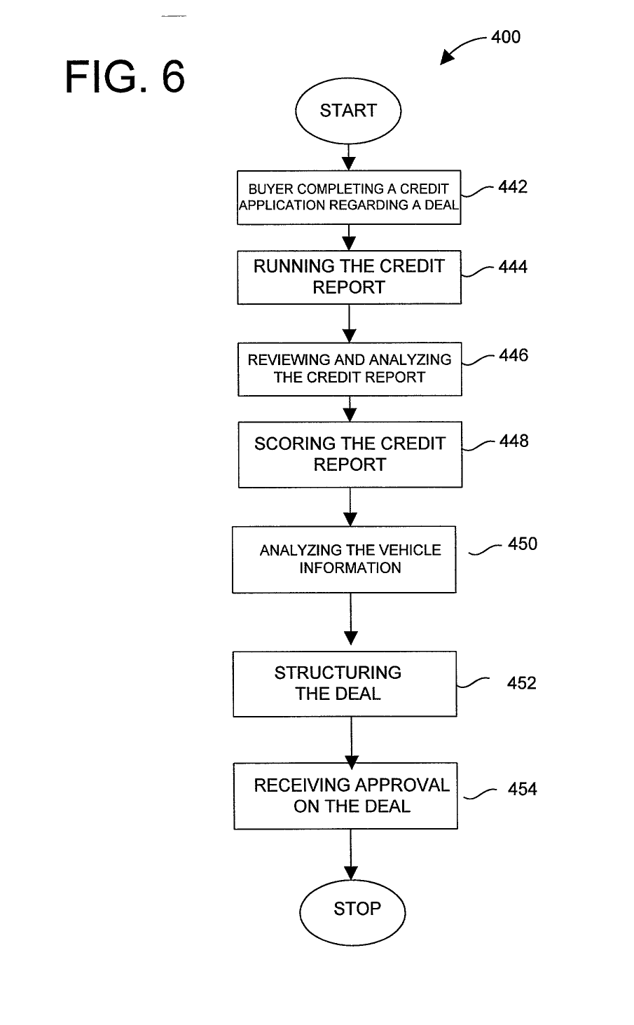

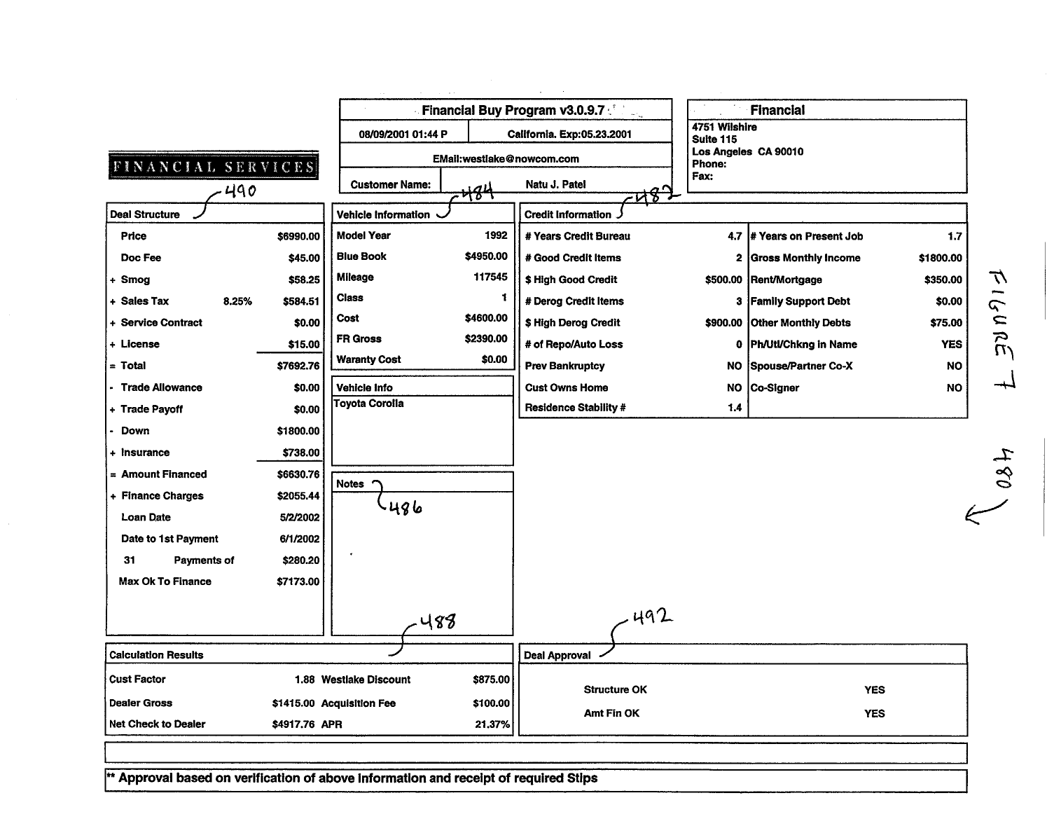

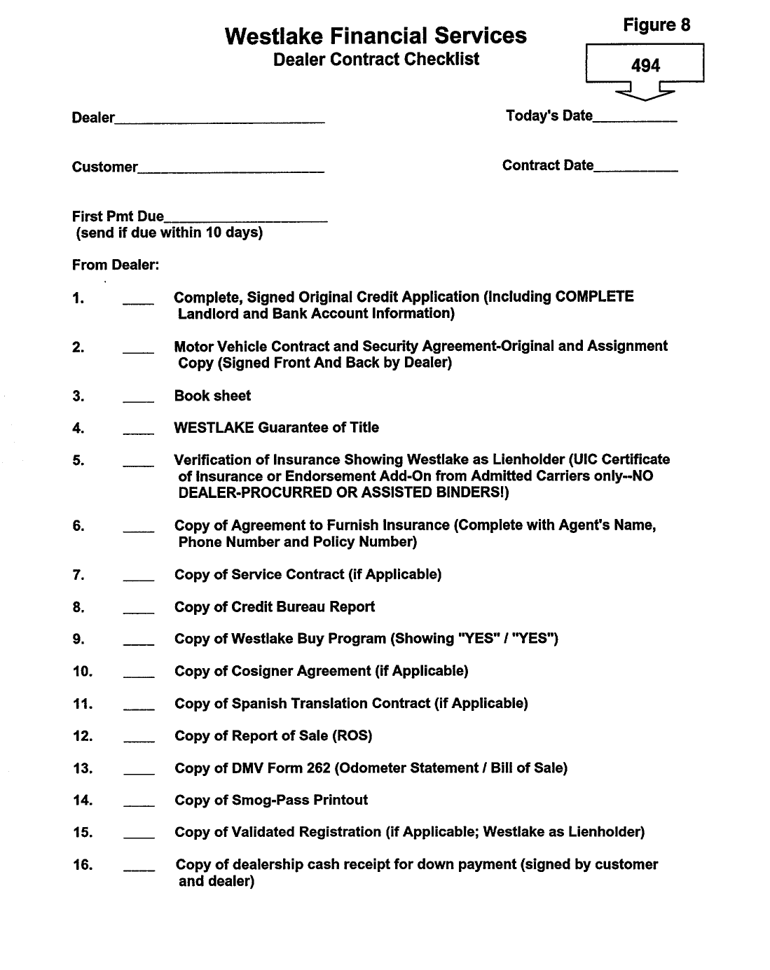

FIGS. 6 and 8, as described below, are exemplary embodiments of data flow diagrams of the DSS depicting the functionality of the system. These flow charts identify the process steps as utilized by the user. The flow charts also depict the overall relationship among various individuals involved in the deal structuring within and outside the business entity. FIG. 7 describes a Deal Structuring User Interface that relates to the implementation of the deal structure process. FIGS. 8 through 15 relate to checklists, references, and underlying documentation.

FIG. 6 is an exemplary embodiment of a flow chart of a deal structuring process 400 that is implemented by utilizing a stand alone computer program installed on a computer described in FIG. 5 (above). Computer program code includes instructions implementing loan processing and approval criteria as well as various code segments to execute the logic of the program relating to parsing of the credit report information, scoring the credit report, analyzing the information pertaining to the buyer and the deal, and finally structuring the deal. The computer program further includes a code segment that provides guidance to the dealer to adjust the deal by utilizing a cartoon character. The guidance is provided based on pre-determined criteria that may vary from state to state based on local rules and regulations governing deals. In one embodiment, the deal refers to a purchase of a car from the car dealer and obtaining financing by the car dealer on behalf of the buyer from a business entity/lender. Deal structuring process 400 includes completing 442 a credit application by a buyer. The credit application solicits information about the buyer, including, but not limited to, a name of the nearest relative, a name of the landlord, gross monthly income, rent or a mortgage amount per month, other monthly debts, residence stability information since age eighteen, and the number of years on the present job. Once the credit application is received, the dealer runs a credit check on the buyer by running 444 a credit report from a credit bureau. Based on the credit bureau printout and credit bureau guidelines, the dealer reviews and analyzes 446 the credit report in detail. The credit report analysis includes, but is not limited to, counting good and bad credit items. This process of counting is also referred to as scoring 448 the credit report. The bad credit items are often referred to as derogatory or derog credit items. The credit report analysis further includes scoring 448 information on the buyer such as, the number of years of established credit, the number of good credit items, the dollar amount related to a highest credit ever granted to the buyer by an institution, the number of derog credit items, the highest dollar amount ever established as a derog credit, the number of repossessions or auto leases, previous bankruptcy, if any, and any information relating to the ownership of a home by the buyer. In addition to counting of good and derog credit items, there are certain items on the credit report which have no effect on the credit rating of the buyer. Additionally, there are other criteria for reviewing, analyzing and scoring the credit report established by the business entity which should be followed by the dealer to ensure that the dealer has complied with the guidelines. The details pertaining to the criteria established by the business entity for dealers, credit application information, the criteria for analyzing the credit report based on credit bureau guidelines, and vehicle classification criteria are summarized in Appendix-A, attached herewith.

The deal structuring process 400 further includes analyzing 450 a value of the car that is being sold based on wholesale book value published by a standardized publication such as Kelley Blue Book or NADA. Kelley Blue Book is a registered trademark, service mark & design mark of Kelley Blue Book Company, California Corporation, located at Irvine, Calif. NADA is the service mark registered on the Principal Register by National Automobile Dealers Association, a Delaware Corporation, located at McLean, Va.

Analyzing 450 the value of the car includes determining the blue book value of the car based on a model year, mileage of the car, class of the car, and approved additions to the car such as air conditioning and so on, and then deducting a pre-determined value for excess mileage or age of the car from the blue book value to arrive at the value of the car. The deal structuring process 400 further includes structuring 452 a deal by adjusting price up or down, adjusting the length of the loan, modifying the amount financed and adjusting other variables.

Structuring 450 the deal is accomplished by the dealer utilizing a deal structure form, also known as a deal structure user interface (shown in FIG. 7 below). Based on predetermined criteria, the dealer receives guidance from server system 42 to adjust one or several terms to get the deal approved according to the guidelines established by the business entity. Once the dealer receives approval from server system 42, the dealer collects a down payment and obtains documentation from the buyer substantiating the information stated by the buyer on the credit application. Approval 454 is received on a structure of the deal if the amount financed by the dealer is acceptable to the business entity. Otherwise, a message is displayed to the dealer on the dealer's computer terminal that the deal is not acceptable and that further modifications are necessary. Once the dealer modifies the variables based on the guidelines displayed to the dealer, the deal is approved.

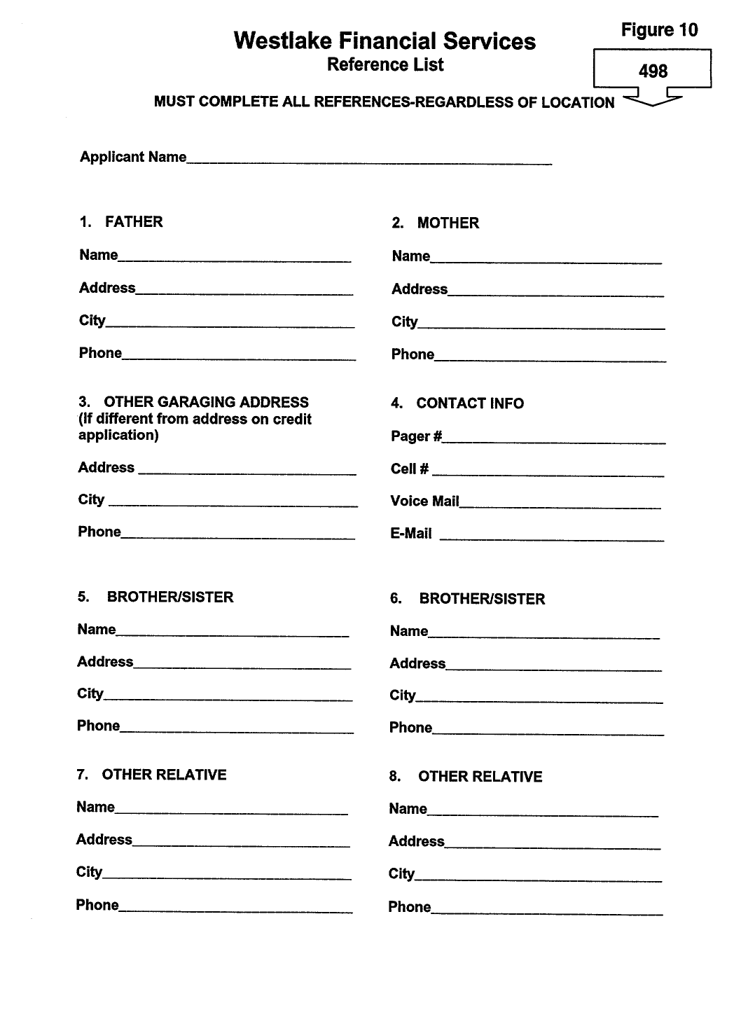

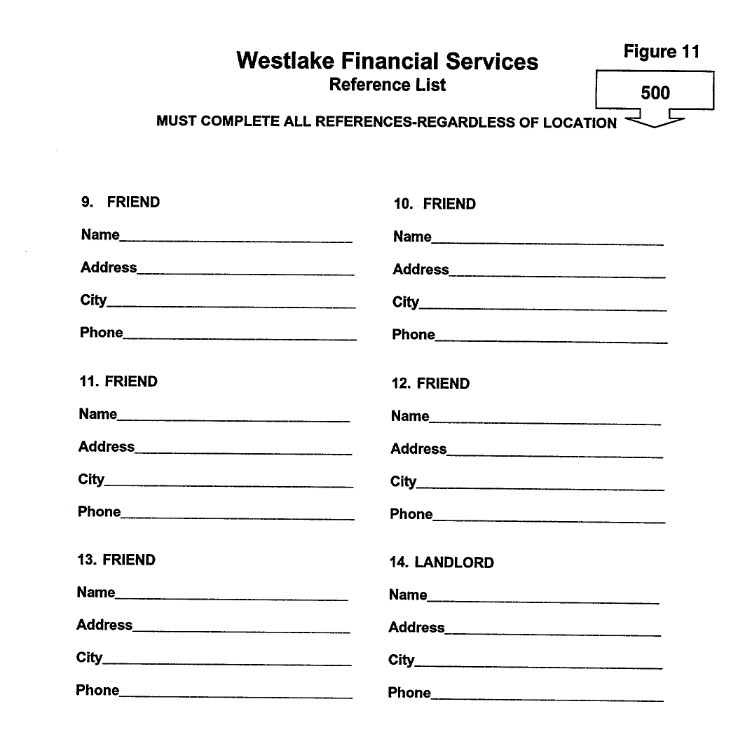

Once the deal is approved and satisfactory documentation is received from the buyer, the dealer delivers the car to the buyer. Upon delivery of the car, the dealer forwards underlying documentation to the business entity for approval and funding of the deal. Based on the documentation, down payment received from the buyer and the verification obtained by the dealer, the dealer gives possession of the car to the buyer. The dealer records appropriate documents including a lien on the car with state and local agencies, as necessary. Once the forwarded documents are received by the business entity, the business entity conducts its own due diligence, approves the deal, and forwards a check to the dealer. In an exemplary embodiment, the forwarded documents include a copy of the summary of the deal (shown in FIG. 7), a dealer contract check list (shown in FIGS. 8 and 9) with all underlying documentation, and a completed reference list (shown in FIGS. 10 and 11).

FIG. 7 is an exemplary embodiment of a deal structure user interface 480. Deal structure user interface 480 is downloaded and displayed by server system 42 (shown in FIG. 2). In yet another embodiment, user interface 480 is downloaded by an interactive user interface, which allows the dealer to alter variables that are factored into the decision making process. A built-in logic in the software permits the dealer to adjust the variables and receive a response from DSS 40. User interface 480, in an exemplary embodiment, displays a Credit Information Section 482, a Vehicle Information Section 484, a Notes Section 486, a Calculation Results Section 488, a Deal Structure Section 490, and a Deal Approval Section 492.

Credit Information Section 482 includes information such as the number of years of established credit, the number of good credit items, the dollar amount related to a highest credit ever granted to the buyer by an institution, the number of derog credit items, the highest dollar amount ever established as a derog credit, the number of repossessions or auto leases, previous bankruptcy, if any, and any information relating to the ownership of a home by the buyer including a residence stability index. Section 482 further solicits information on the number of years on the present job, gross monthly income, rent or mortgage amount per month, and other monthly debts. Additionally, the dealer is asked to provide information such as whether a telephone bill, a utility bill or a checking account is in the buyer's name, whether there is a co-signer and, if so, is the co-signer a spouse of the buyer. Vehicle Information Section 484 seeks specific information such as the model year, blue book value, mileage on the vehicle and other related information. Notes Section 486 permits the dealer to make specific notes, which are relevant to the transaction.

Once the dealer has completed appropriate information on Deal Structure Section 490, the dealer transmits a request to DSS 40 to compute the results of the deal based on the information submitted on Credit Information Section 482, Vehicle Information section 484, and Deal Structure Section 490. The results are computed based on pre-stored criteria coded into the software.

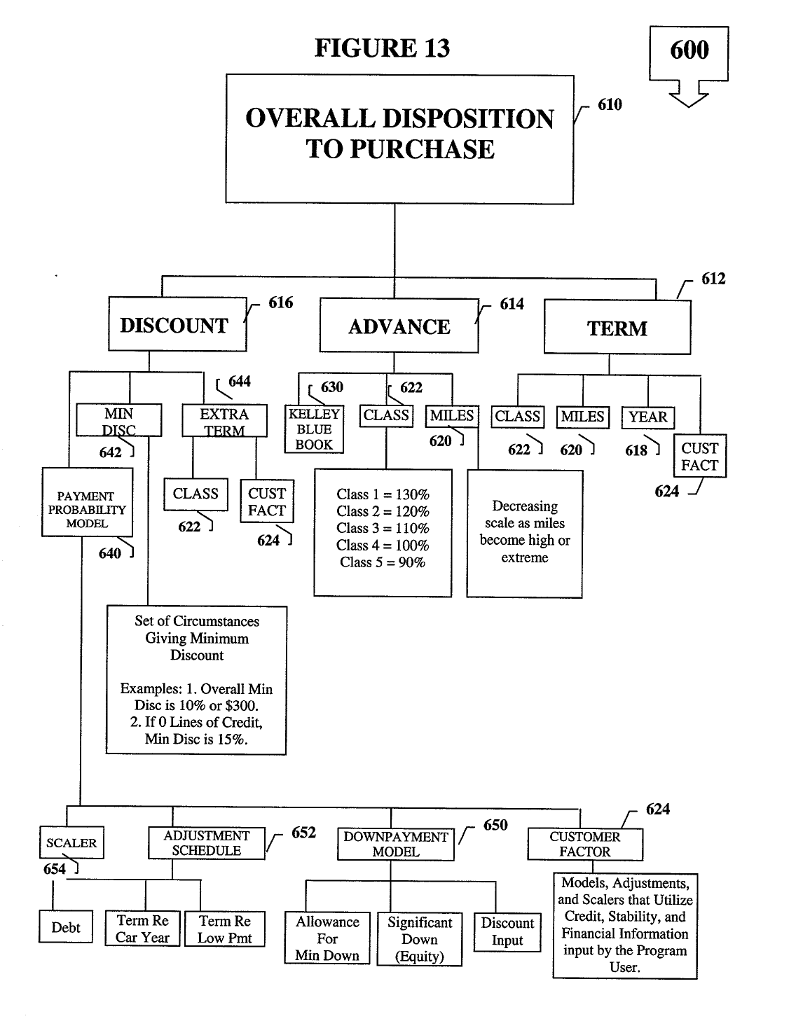

The pre-stored criteria, often referred to as credit guidelines are developed based on various risk factors and are explained hereunder in FIG. 13 below. These credit guidelines are coded into a software program as computer program instructions, which are stored on disk storage 362 (shown in FIG. 5). The credit guidelines may vary from state to state to ensure compliance with the local and state laws. The credit guidelines for each state also vary based on other variables, such as local economical conditions within the state, dominant industry of the state, and demographic of potential used car buyers.

Once the dealer transmits the request to compute the results, microprocessor 330 (shown in FIG. 5) retrieves and executes the instructions. The results are calculated and displayed under Calculation Results Section 488, including final summary regarding deal approval in Deal Approval Section 492. Other information such as the customer name (i.e. buyer's name) 494, the address of the business entity 496 and any other comments 498 are also displayed on user interface 480.

FIG. 8 is an exemplary embodiment of a first page 494 of a Dealer Contract Checklist. First page 494 requires the dealer to complete essential information pertaining to the deal, such as, the dealer's name, date, the customer's name, and the contract date. The dealer is further required to go through the checklist and complete the checklist as appropriate. The dealer collects the documents as identified on the checklist for submission to the business entity.

FIG. 9 is an exemplary embodiment of a second page 496 of the Dealer Contract Checklist. This is a continuation of the Dealer Contract Checklist.

FIG. 10 is an exemplary embodiment of a first page 498 of a Reference List. Reference List solicits information on buyer's references.

FIG. 11 is an exemplary embodiment of a second page 500 of the Reference List. Second page 500 is a continuation of the reference list soliciting additional information on the buyer.

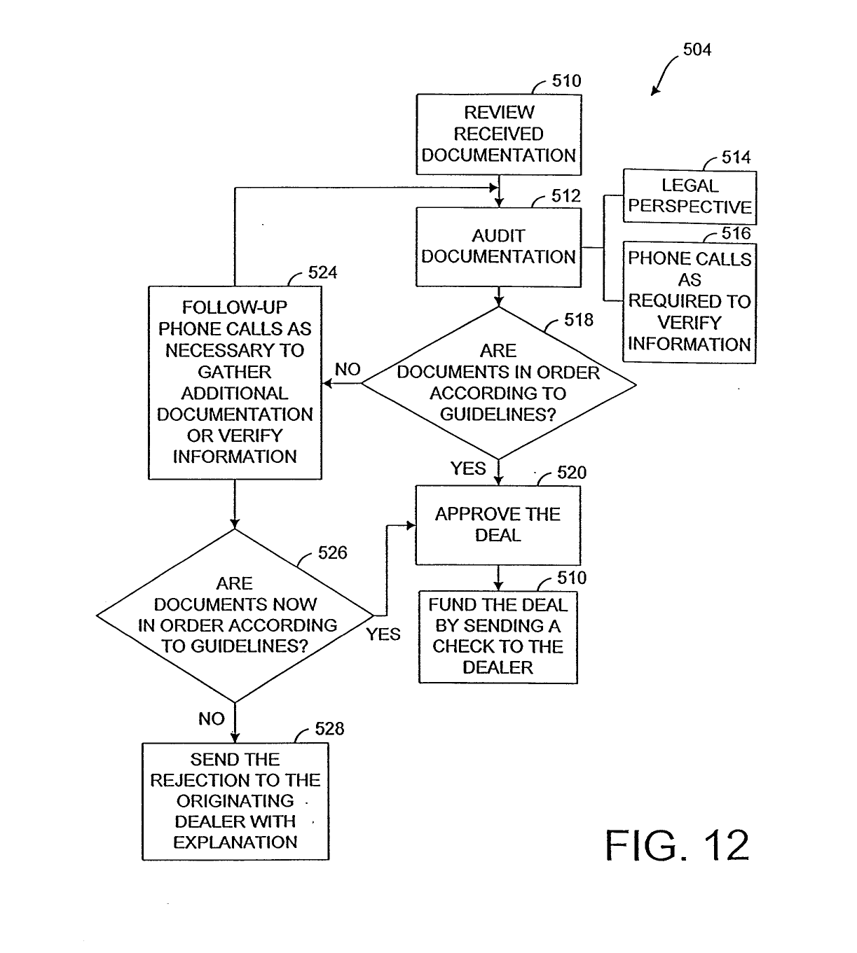

FIG. 12 is an exemplary embodiment of a due diligence process 504 undertaken by the business entity on the documents received from a dealer for a given deal. In an exemplary embodiment, the documents received from the dealer include, but are not limited to, the documents identified in FIGS. 7 through 11 and all the underlying documents referenced therein. Due diligence process 504 includes reviewing 510 received documentation and auditing 512 the documentation. Auditing 512 documentation involves ensuring compliance with state and local governmental requirements 514. These requirements are reviewed from an underwriting perspective to ensure that the legal requirements have been met by the dealer. Auditing further includes verifying information 516 on the deal by making telephone calls and individual inquiries, as necessary. Once the auditing is completed, a threshold question 518 is addressed as to whether the documents are in order in accordance with the guidelines established by the business entity. If the documents submitted by the dealer are according to the established guidelines of the business entity, the deal is approved 520. Upon approval of the deal, the deal is funded 522 by sending a check to the dealer. If the documents are not in order according to the guidelines established by the business entity, follow-up telephone calls 524 to the dealer are made to gather additional documentation or verify the existing information. If necessary, telephone calls are also made to the buyer who submitted the initial application for the deal. Once the additional documents are gathered, again an inquiry 526 is made as to whether the additional documents combined with the original documents submitted by the dealer are in compliance with the business guidelines and the underwriting criteria. If this new set of documents satisfies the guidelines established by the business entity, the deal is approved and funded by the business entity. If the documents are still not in order after making a diligent effort to acquire these documents to ensure compliance, a rejection letter 528 advising that the deal has been rejected is sent to the dealer with a detailed explanation.

The due diligence process established by the business entity is consistent for all dealers. Due diligence process may vary from state to state depending on the legal requirements imposed by a given state. However, the objective of the due diligence process is to comply with the legal requirements and to ensure that the quality of the loan given out by the dealers in the field meets minimum requirements. Under this system, dealers are making decisions based on a software program that has been deployed in the field. The software program includes the detailed decision criteria and guidelines established by the business entity. The objective of the business entity's review is, in essence, to ensure compliance with the business guidelines. So, if the dealer has complied with the business entity's guidelines, deals falling within those criteria are generally approved.

III. Exemplary Embodiment of Credit Guidelines Executed by the Deal Structuring System

The business entity does not have any minimum credit guidelines. This does not mean that the business entity approves every contract/customer structure, nor that the business entity does not differentiate between one credit risk and another. The business entity certainly follows credit, structure, stability, and ability guidelines. The business entity combines these factors to determine approval or non-approval of a certain customer/structure combination. However, there are no particular minimums on any specific guideline and therefore, conceivably, any credit profile could be approved under certain circumstances. For example, a customer with no paid or current credit, 20 unpaid accounts including 4 repossessions, one month at current residence, with one dollar income per month could be approved on a $5,995 car with $5,800 down payment, financing $799 for 2 payments of $407.50, with a discount of $400 plus $100 acquisition fee. While this is an extreme and unlikely example, one can extrapolate from it the kind of purchase structure the business entity may demand with a more conforming customer. Further, this policy frees the business entity from suffering the consequences of human error and frailty that the business entity may face when allowing for exceptions to one or another guideline.

Without minimum guidelines, the business entity is free to rate the entire deal proposal as a whole without ever making exceptions, free to make a risk-reward judgment without compromising principles, and free to value higher any deal proposal that is better than another deal proposal.

While there are no minimum credit guidelines, there are certain deal structure minimums and guidelines that are incorporated into the software, as follows:

1) Maximum/Minimum Amount Financed

There is no Maximum/Minimum Amount Financed established by the business entity, although the business entity does retain a pre-determined minimum discount. In an exemplary embodiment, such a discount is 10% or $300, whichever is greater. Additionally, DSS 40 automatically determines the risk on a higher or lower dollar contract.

2) Amount Financed Per Kelley (or NADA) Book

The Business entity allows a maximum advance of 36-130% of Wholesale Kelley Bluebook. In states where NADA guide is used, the business entity allows an advance usually less than, and rarely exceeding, the advance under the Kelley Program, although the NADA Trade Value is used to determine the advance.

The variance in advances is determined by the actual model being sold and the miles on the unit. The business entity classifies a vehicle into one of 5-7 categories which are used in determining the variance. Most units that have less than 120,000 miles will be allowed 90-130% of Wholesale Kelley Bluebook (see Class Chart). The business entity follows a conservative approach in lending. For example, the business entity does not adjust the Kelley Bluebook value for low miles and other “soft” adds. The business entity also verifies every claimed Kelley feature with the customer prior to funding a contract. If some features are not verifiable, then the business entity re-evaluates the contract using the correct book amount. Additionally, the business entity does not split, “holdback,” or allow for “overadvances.” The dealer is given the option to either properly re-work the contract or the business entity will fund only what it allows regardless of the amount of the overadvance. There are other variables, which may be adjusted to make the deal favorable for the dealer as well as the business entity.

3) Amount of Payment

In an exemplary embodiment, the minimum payment is $140. There is no maximum payment. The business entity looks less favorably on loans with low payments over an extended period of time.

4) Interest Rate

In an exemplary embodiment, the business entity pre-determines the interest rate based on laws and regulations of each state where the business entity conducts its business. For example, the interest rate charged is 24% APR (simple interest) in Tennessee and Arizona; 21% APR (simple interest) in Colorado; 10-16 add-on (legal maximum) in Florida; 18-29% in North/South Carolina (legal maximum); and 12% add on in California.

5) Term

The term is determined by Vehicle “Class,” year, miles, and creditworthiness (i.e., defined as a Customer Factor). In addition, dealers may “buy” an additional term up to 6 months for a percentage of the amount financed. This percentage is dependent on the Customer Factor. In an exemplary embodiment, the term may not exceed 48 months.

In yet another embodiment, the business entity accepts a 31-month term as “normal,” although the vehicle indicated may be too old or the Customer Factor may be too low to merit such a term. In such a case, the business entity looks at the deal less favorably (i.e., require a higher discount). In addition, the 31-month term is used to determine the payment for the debt ratio component. This means that if the customer chooses to have a shorter term than 31 months, the debt ratio will remain as if the payment was drawn out over 31 months. Further, even if the program allows a longer term than 31 months, the debt will still be calculated with a payment commensurate with a 31 month term.

6) Discount

The discount ranges from 10% to 50% of the amount financed, less insurance and service contract allowance. For example, if the amount financed is $5,000+$500 Auto Insurance +$500 for service contract for a total of $6,000, the business entity will calculate the discount based on a total of $5,250 ($6,000−$500 Insurance−$250 Allowable service contract), instead of $6,000. The discount will range from $525-$2,625. In an exemplary embodiment, the minimum discount on any deal is $300 regardless of how small the amount financed. However, the business entity maintains the flexibility to accept the deal at a much lower discount than $300, if necessary.

IV Various Logical Components of Credit Guidelines That are Built Into the Deal Structuring System

DSS 40 (shown in FIG. 2) determines the offer that the business entity makes to a dealer to purchase a submitted contract. As a discount lender, the options for the business entity are: a) not offer to purchase any contract featuring the submitted buyer under any circumstances, b) offer to purchase the particular contract submitted for a certain discount based on the risk of that particular contract, or c) offer to purchase a different contract with the same buyer for some certain discount. Since the business entity is interested in maximizing deals for the dealers based on pre-defined risk guidelines, DSS 40 suggests to the dealer how best to structure a loan for a given customer, including the type of vehicle and the price range most appropriate for the customer. The business entity will discourage a certain customer/loan structure combination by either not allowing for it or by placing a high discount for its purchase. The discount and advance are the regulatory mechanisms that keep a deal within the acceptable risk limits.

FIG. 13 is an exemplary embodiment of a logical process 600 pertaining to overall disposition to purchase 610. In general, there are three main logical decisions involved in the business entity's approval of a contract through DSS 40 (shown in FIG. 2), a term 612, an advance 614, and a discount 616.

A) Term 612:

Term 612 is determined by Vehicle “Class,” year, miles, and creditworthiness (i.e., defined as a Customer Factor). In addition, dealers may “buy” a term up to 6 months for a percentage of the amount financed. The percentage is dependent on the Customer Factor. The appropriate term 612 is determined by a year of the vehicle 618, a mileage 620, and a Class 622 combined with a Customer Factor 624. Class 622 of the vehicle determines the reliability of the vehicle of the given year 618 and mileage 620. Customer Factor 624 determines the business entity's willingness to forego some early equity and collect extra payments on a particular customer. Should the contract call for a shorter term than that allowed by DSS 40, the business entity looks more favorably upon the approval of the deal.

B) Advance 614

Advance 614 allowed is determined by the Wholesale Kelley Bluebook (NADA Trade Value in some states) 630, mileage 620, and Class 622 of the vehicle.

C) Discount 616

Discount 616 is determined in part by how far the dealer stretches term 612 and advance 614. Discount 616 is determined by utilizing a Payment Probability Model 640, a Minimum Discount Model 642, and an extra term model 644. Minimum Discount Model 642 determines minimum discounts for certain sets of input, and Extra Term Model 644 allows the dealer to “buy” a longer term than the term model allows, for example, up to 6 months. The price for the “extra term” is determined by Class 622 of the Vehicle and Customer Factor 624.

i) Payment Probability Model 640

Payment Probability Model 640 is made up of several components: a Customer Factor 624, a Down Payment Model 650, a schedule of adjustments 652, and an overall Scaler 654. Scaler 654 is a multiplier constant or variable which increases or decreases other factors to determine the payment probability or some component of the payment probability. Once the payment probability is determined, the loss probability follows (loss probability=(1-payment probability)). The loss probability is then multiplied by the amount financed (with scalers) to give a projected amount of loss on a particular contract.

Customer Factor 624, as it relates to Payment Probability Model 640, is only a part of the mechanism that determines discount 616 and/or term 612.

The business entity focuses on Payment Probability Model 640 in making the business decision. Payment Probability Model 640 relates to risk/reward (i.e., at what discount the proposed deal is acceptable considering the precise risk associated with it). Other factors that are utilized in evaluating the deal by DSS 40 (shown in FIG. 2) are either to mitigate certain circumstances (like debt ratio or term) or scale Customer Factor 624 in one way or another to influence the payment probability result. For example, the maximum advance is strictly related to the vehicle at hand and has nothing to do with any customer credit characteristics or with the deal structure.

In an exemplary embodiment, creditworthiness can be rated as a letter grade from A-F with the letter grade A, being the best, and the letter grade F, being the worst. These letter grades are then assigned a corresponding numerical value, such that:

A=5

B=4

C=3

D=2

F=1

Hypothetically, if a buyer of “A” creditworthiness puts 20% of the purchase price as a down payment on a vehicle, then the probability that the loan would be paid off successfully is 95%. That is, if the business entity financed to 1,000,000 “A” customers with 20% down, 950,000 of the total customers would pay and that the business entity would take a loss only on 50,000 of the customers. If the business entity continues to relate creditworthiness, down payment, and the payment probability in the same way down the credit scale, then the business entity can estimate the down payment needed for a “B” customer to have a 95% payment probability. If the business entity multiplies the two factors (the credit score and the down payment) together for the “A” customer, i.e., say that

(5)(0.20)=0.95 payment probability

then the business entity can determine the down payment needed for the “B” customer to be as follows:

(5)(0.20)=(4)(X)

X=0.25

The “B” customer needs 25% down payment to have a 95% payment probability. One can see that both multiply out to equal 1.00 to give a 0.95 payment probability. So if the business entity multiplied both by 0.95, then both equations would equal 0.95. Based on the above rationale, the down payment to obtain a 95% probability of success for a given set of credit scores would be as follows:

| Credit Score × | Down Payment | × | Scaler = | Payment Probability |
|---|---|---|---|---|
| 5 | .20 | | .95 | .95 |
| 4 | .25 | | .95 | .95 |
| 3 | .33 | | .95 | .95 |
| 2 | .50 | | .95 | .95 |
| 1 | 1.00 | | .95 | .95 |

After developing the above equation to solve for the down payment needed for a known Credit Score and payment probability, the business entity can use the same equation to find the payment probability for any Down Payment and Credit Score:

| Credit Score × | Down Payment | × | Scaler = | Payment Probability |
|---|---|---|---|---|
| 3.00 | .12 | | .95 | .342 |
| 2.86 | .35 | | .95 | .951 |
| 1.50 | .41 | | .95 | .585 |
| 4.08 | .30 | | .95 | 1.163 |
| 0.61 | .25 | | .95 | .145 |

In an exemplary embodiment, the payment probability is arrived as discussed above. The payment probability, in reality, cannot be greater than 1.00. Based on the above, since it is not economical to finance the contract with only 14.5% probability of paying, the scalers and the other information are utilized in making a final decision. Of course, increasing the down payment reduces the risk for the business entity and therefore increases the probability to obtain approval.

The discount is treated as follows: First, the discount adds to the down payment. While the discount did not come from the customer's pocket, the discount does add to the lender's equity (i.e. business entity's equity), and, as such, can be treated the same as the down payment. Second, the discount subtracts from needed payment probability. While it does not make the customer more likely to pay, it does subtract from the lender's eventual loss, and, as such, can be treated as additional likelihood to obtain payment (or for the lender, to not suffer a loss).

For example, for a customer with a Credit Score of 1.50, the payment probability is only 58.5%, which is far short of the needed 95% to buy the deal. However, if the business entity adds a 20% discount to the deal, the down payment is increased to 13.8% (after allowing for the initial down, tax and license). In addition, the business entity's target payment probability is now only 75%, because the business entity has a built-in loss reserve of 20% on the loan.

Using the standard equation for the exemplary embodiment described above, the business entity has a probability of (1.50)(0.41+0.138)(0.95)=78.3%. This is greater than the 75% payment probability needed. Therefore, based on the above rationale, a Credit Score of 1.50 with 41% down payment and 20% discount is an acceptable contract for purchase by the business entity.

a) The Customer Factor

In an exemplary embodiment, of all the components that make up Payment Probability Model 640, Customer Factor 624 is a heavily weighted factor in determining payment probability. However, Customer Factor 624 is not the sole determining factor in the business entity's decision to approve a purchase proposal. The three other broad components to the Payment Probability Model (Down Payment Model 650, Scaler 654 and Adjustment Schedule 652) also play an important role in the decision making process. In fact, Payment Probability Model 640 itself is only one part of the discount 616 determination, and the discount determination is only one of three components to the business entity's overall disposition to purchase a contract, as submitted to the business entity via DSS 40 (shown in FIG. 2).

Customer Factor 624, representing the major portion of “credit guidelines,” is determined mainly by the input on the right side of the deal structure user interface (shown in FIG. 7 above). In an exemplary embodiment, there are approximately 15 credit, financial or stability related questions about the customer, which the user (the dealer) inputs. Each of these questions represents a possible number of positive or negative points, which are scaled alone or in combination with each other (or sometimes both) to add or subtract from the Customer Factor, which begins at 0.00. Thus, conceivably, a Customer Factor could end up being less than 0.00. However, DSS 40 limits the end result to fall in the range of 0.00-4.95.

b) The Scaler

Scaler 654 is developed out of the input itself. This is called a primary scaler model. For example, assume that one of the questions for the user is time on the job, and the answer is 3.2 years. DSS 40 has a maximum point limit for time on the job. In order to determine the percentage of the maximum point limit that will be allowed for 3.2 years, a primary scaling model for the time on the job evaluates the given input, yielding a higher percentage for a bigger number. In fact, the percentage will increase at an increasing rate as the number increases. The rate of increase in any situation is based on a statistical analysis of previous purchases that have been paid and not paid. Additionally, other experience factors are built into the logic that reduces the risk and increases the probability of success.

Scaler 654 also takes several factors into account, such as income, in determining how much credit is to be given for the time on the job. There are additional scaling models built into DSS 40 intended either to influence the Customer Factor given a certain set of circumstances, or to address another issue of the decision making process unrelated to the Customer Factor. These additional scaling models are called secondary or mitigating scaler models.

1) Number of Years on the Credit Bureau

The number of years on the credit bureau factor is heavily weighted in evaluating the decision. Used alone, it compiles points for 3 years, after which this factor is significant only in some mitigating scalers (such as looking to give extra points for a stronger Bankruptcy candidate-clearly a Bankruptcy within the first few years of credit history is a substantial negative indicator).

2) Number of Years on the Present Job

The number of years on the present job is perhaps the strongest and most important factor. Only “Number of Good Credit Items” can add more points to the Customer Factor, but that is countered with several mitigating scalers and “Number of Derog Credit Items.” DSS 40 contains a primary scaling model just for the job factor, which determines the points to be given for the time on the job per historical data. Alone, it compiles points up to 4.5 years. In addition, time on the job is used for some mitigating scaler models that require some minimum time on the job to have an effect.

3) Residence Stability Number

This factor has a scaling factor similar to time on the job, but has less overall impact. The Residence Stability Number compiles fewer points over 8.0 years than the time on the job does over 4.5 years.

4) Number of Good Credit Items

The business entity supplies its dealers with a chart showing what TRW line items to count as “good,” “derog,” both, or neither. This question asks the dealer to input the total number of items that can be counted as “good.” The decision process permits adding more points for this individual factor than any other, but it too has a scaling model that will add or subtract from the allowable points. The scaling model in this case may contain, for example, the ratio of “good” and “derog” items—if the ratio is 10 derog to 1 good, the scaling model may interpret that as diminishing from the 1 good, that it may be an anomaly, and therefore fewer points will be allowed for the 1 good than may be otherwise.

The DSS will generally stop allowing points after 5 “good” credit items, but the total number may still have an impact on other areas of the program having to do with mitigating scalers (such as looking for a minimum number of good items to identify a stronger bankruptcy customer).

5) High Good Credit

High good credit relates to the highest amount of credit established on an account considered to be “good.” The high good credit factor has less weightage than the number of good credit by itself, but it does have some important implications in the mitigating scalers, most importantly its ratio to the high derog credit.

6) Number of Derog Credit Items

This factor works in conjunction with the number of good credit items. It should be noted that the two are not combined to make up a credit picture. That is, 5 good and 3 derog is not the same as 2 good and 0 derog. The number of derog credit items is a negative factor, which subtracts points from the customer factor. The customer factor will continue to accrue negative points as this number rises.

7) High Derog Credit

This factor has no meaning by itself; it is purely used in primary scaler models and mitigating scaler models. However, it has substantial influence in the decision making process within those models.

8) Number of Repossessions/Auto Losses

The business entity takes a conservative view in defining a repossession. The DSS 40 takes a fairly harsh view of repossession It carries substantial negative points and also sets minimum discounts which are especially severe in the case of multiple repossessions. It is very difficult to accumulate enough points for it during the decision making process to accept a repossession, or especially multiple repossessions, without having to substantially alter the loan structure to allow for the greater risk involved. In such a case, the minimum discounts will still mitigate the risk to a great degree. It should be noted that the combination of a repossession and bankruptcy will somewhat temper the effect of the repossession if DSS 40 does not classify the bankruptcy as frivolous due to various other factors.

9) Previous Bankruptcy

This is a negative factor by itself; however, combined with other highly positive indicators, the mitigating scalers pertaining to bankruptcy can so influence the Customer Factor as to actually have a positive effect. This falls in line with the generally accepted concept of a “strong bankruptcy” customer being the most desirable customer in the sub-prime market. However, the business entity remains more conservative overall on this type of the customer than most of its competition.

10) Customer Owns Home

This factor shows most of its impact as a stand-alone concept, although it has a favorable impact in the bankruptcy mitigating scaler, among others. It has substantial impact when answered affirmatively, although it can be tempered if High Good Credit does not indicate a home loan of some sort.

11) Gross Monthly Income

Gross monthly income has an impact by itself and has tremendous impact in the debt ratio portion of the Payment Probability Adjustment Schedule. Also, gross monthly income influences some of the mitigating scalers.

12) Total Monthly Debts

Total monthly debts impact is determined by its ratio with gross monthly income. Higher debt ratios will result in some negative points, although the impact on the Payment Probability Adjustment Schedule will be much greater.

13) Phone or Utility Bill in Customer Name

The customer must have a telephone in the house in order to be approved under any circumstances. This question refers to the customer having the home telephone or a utility in his/her name, which lends to stability and also some measurement of creditworthiness if there is little or no credit experience. This factor has less impact than most of the above, but is a part of many mitigating scaler models, and does have a greater degree of impact depending on the lack of credit depth.

14) Spouse Co-Signing

This is an additional factor that is counted only if both spouses sign on the contract. Alone, it has a minor positive impact on the Customer Factor. However, it allows the dealer to combine incomes, which may alleviate a debt ratio problem.

15) Other Co-signers

When others co-sign the loan in addition to the spouse, it gives a small positive point boost. Both spouse and other co-signer also have a place in mitigating scaler models having to do with short time on bureau or limited credit.

c) The Down Payment Model

The Down Payment model is the second component in the Payment Probability Model. As discussed above, the payment probability is computed by:

(Credit Score)×(Down Payment)×(Scaler)=Payment Probability

wherein Credit Score is represented by the Customer factor, down payment by the Down Payment Model, and the scaler by the Scaler/Adjustment Schedule.

The Down Payment Model determines how much down payment will be credited to the deal. First, it includes the discount input by the user, the reason for which is discussed earlier. Second, it includes an allowance for a minimum down payment. Third, it includes a “significant down” as determined from yet another mitigating scaler model which determines how much of the down is “to be believed,” which further depends on whether the actual amount financed is substantially less than the allowed amount financed. In summary, DSS 40 scales the advance to fit the market value of the car and not the book value.

d) The Adjustment Schedule

The Adjustment Schedule adds or subtracts points directly from the payment probability. The factors involved are debt ratio and the term. As noted earlier, the customer factor is already somewhat influenced by any change in the debt ratio. This adjustment does not affect the customer factor; it is a direct downward adjustment to the overall payment probability and begins after the debt ratio becomes 40%, increasing its intensity at 50%. An extremely high customer factor and/or down payment determination can overcome even the highest of debt ratios.

ii) Minimum Discount

Minimum discount 642 refers a minimum discount provided by the business entity to a dealer based on a set of circumstances. In an exemplary embodiment, the business entity may set an overall minimum discount to be 10% or $300. In another exemplary embodiment, the business entity may set the minimum discount to be 15% for zero lines of credit.

iii) Extra Term

As stated above, the term 612 is determined by a year of the vehicle 618, a mileage 620, and a Class 622 combined with a Customer Factor 624. Class 622 of the vehicle determines the reliability of the vehicle of the given year 618 and mileage 620. Customer Factor 624 determines the business entity's willingness to forego some early equity and to collect extra payments on a particular customer.

As explained, DSS 40 eliminates the need for the dealer to get approval on the deal from the business entity without discussing the deal details with a representative of the business entity. DSS 40 provides capability to the dealer to make deals and approve deals as long as the dealer has complied with the business entity's pre-defined criteria. DSS 40 facilitates compliance by advising the dealer during the deal structure process. However, the dealer must meet the requirements related to documentation based on the business entity guidelines. DSS 40 helps create a stronger working relationship between a dealer and the business entity, expedites the deal approval process, and offers the dealer and his buyer various options in structuring the deal.

In a further embodiment, client system 44, as well as server system 42, are protected from access by unauthorized individuals. As described, DSS 40 is an interactive searchable database 50 for all loans/transactions related information, which provides flexibility to users, business executives as well administrators of DSS 40 to stay current with the related information to-date. The system provides the ability for managers, employees and database administrators to directly update, review and generate reports of current as well as past loan transactions.

V. Flowchart Depicting Web-Based System Functionality

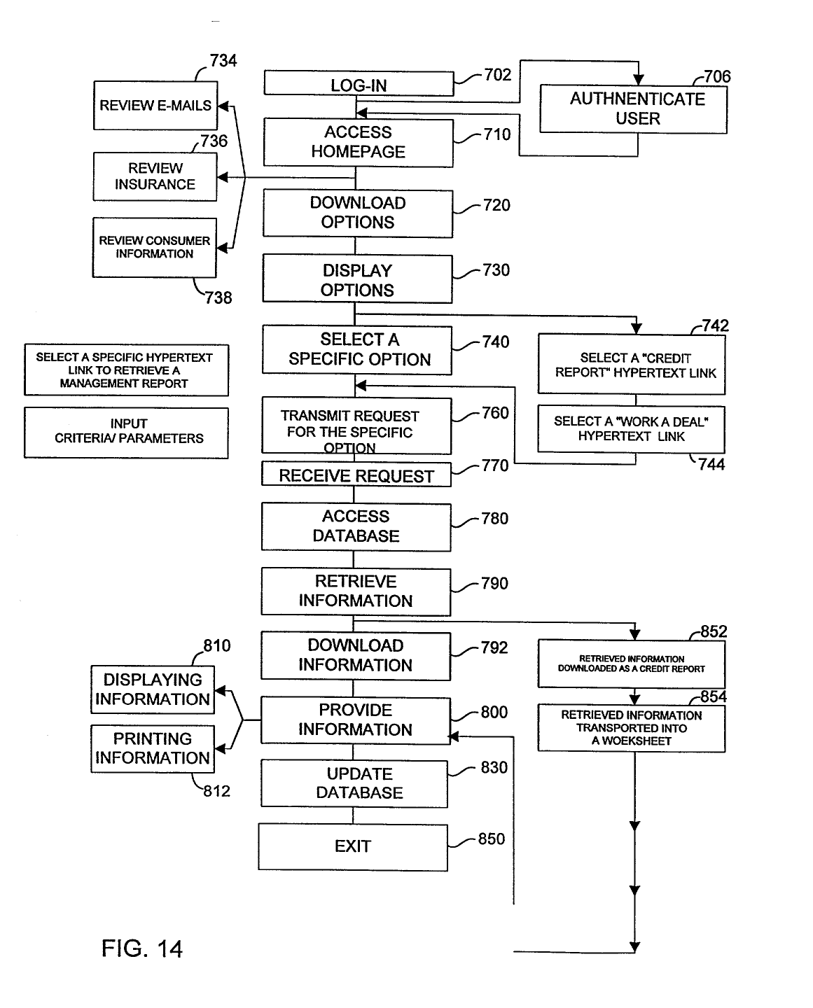

FIG. 14, as described below, is an exemplary embodiment of data flow diagrams of the DSS depicting the functionality of the system. The flow chart identifies the process steps as utilized by the user. Additionally, the flow charts discussed in FIGS. 1, 6 and 12 (described above) depict the overall relationship among various individuals involved in the deal processing within and outside the business entity.

FIG. 14 is an exemplary embodiment of a flowchart 700 depicting Business Process Flow. Through a welcome screen, a dealer, also referred to herein as a user, having an authorized access, accesses the system by logging 702 onto system 40 (shown in FIG. 2) with a user ID and a password. Once the user has been authenticated 706 based on the user ID and the password, the user is provided access 710 to the system.

Under the web-based system 40, the user accesses 710 home page of the web site through client system 14 (shown in FIG. 2). Server system 42 (shown in FIG. 352) downloads 720 and displays 730 several options. In an exemplary embodiment, after the user has been authenticated the user is provided access to Review e-mails 734, Review Insurance Options 736, and Review Consumer Information 738.

Once the user selects 740 a specific option out of various hypertext links, including, but not limited to, Credit Reports 742 on a specific transaction, or Work a Deal 744, the selected request is transmitted 760 to server system 42. Transmitting 760 the request is accomplished either by a click of a mouse or by a voice command. Once server system 12 receives 770 the request, server system 12 accesses 780 the database server 16 and retrieves 790 pertinent information from database 50 (shown in FIG. 2). The requested information is downloaded 792 and provided 800 to client system 44. Server system 42 provides 800 the requested information to the user by either displaying 810 the information on the user's display or by printing 812 it on an attached or a remote printer. The user continues to search the database for other information, updates 830 the database with new or revised information or exits 850 from system 10.

In another embodiment of the invention, the retrieved 790 information is downloaded as a credit report 852. The credit report is then analyzed and evaluated. In yet another embodiment of the invention, the retrieved information is transported into a worksheet 854 or another user interface thereby avoiding direct manual input by the user.

In yet another embodiment of the invention, the retrieved information is printed in a pre-determined management report format. The home page displays several options identified above and also displays the options for retrieving various management reports. If the user wishes to obtain management reports, the user may obtain the reports by selecting 870 a specific hypertext link. Once the user selects 870 a hypertext link, the user then inputs 872 criteria/parameters of the report and transmits 760 a request to the server system by selecting a submit button (not shown). Transmitting 760 the request directs server system 12 to retrieve 790 the data from centralized database 50 (shown in FIG. 2) and provides 800 the data to the user on the user's interface in a pre-determined format.

In yet further embodiment, once the user selects 740 a specific option relating to “Work a Deal” 744 out of various hypertext links, the request is transmitted 760 to server system 42. Under this embodiment, the credit information of the buyer is loaded onto server system 40 and then to a specific customer information section of the user interface, which is utilized to work out the deal. Once the customer information is loaded, the dealer works the details of the deal and approves or rejects the buyer's request for a specific deal.

In yet another embodiment (not shown), once the user enters the web site, the server system 42 downloads several sections that are displayed by utilizing a top frame. The top frame of the web site utilizes five different navigational buttons to guide the user through these various sections. In an exemplary embodiment, these sections are: “About Westlake”, “New Dealer Information”, “Dealer Network”, “Retail Customers”, and “Careers”. Each navigational button permits the user to access additional sub-sections provided under each section.

For example, the Dealer Network section offers various options, such as an Underwriting option, a Dealer Documents option, a Warf Webcam option, a Fleet Services option, and a Buy Program Install option. Each of these options download specific information and documents that are stored on database server 46 (shown in FIG. 2). Once the user selects the Underwriting option hypertext link, server system 42 downloads and displays deals history identifying the outstanding deals, decided deals, approved deals and the rejected deals. The user may access any of the deals that are displayed by the server system either to obtain the current status or to work the deal. In another exemplary embodiment, if the user selects the Dealer Documents option hypertext link, the server system downloads the specific list of documents including the pre-stored credit criteria based on the user defined criteria. The pre-stored criteria, often referred to as credit guidelines stored on server system 42, are developed based on various risk factors and are explained in FIG. 13 above. These credit guidelines are coded into a software program as computer program instructions, which are stored on disk storage 362 (shown in FIG. 5). The credit guidelines for each state vary based on various variables, such as local and state laws, local economical conditions within the state, dominant industry of the state, and demographics of potential used car buyers. In a further embodiment, client system 44, as well as server system 42, are protected from access by unauthorized individuals. As described, DSS 40 is an interactive searchable database 50 for all loans/transactions related information and provides flexibility to users, business executives as well administrators of DSS 40 to stay current with the related information to-date. The system provides the ability for managers, employees and database administrators to directly update, review and generate reports of current as well as past loan transactions.

VI. Detailed Web-System Functionality

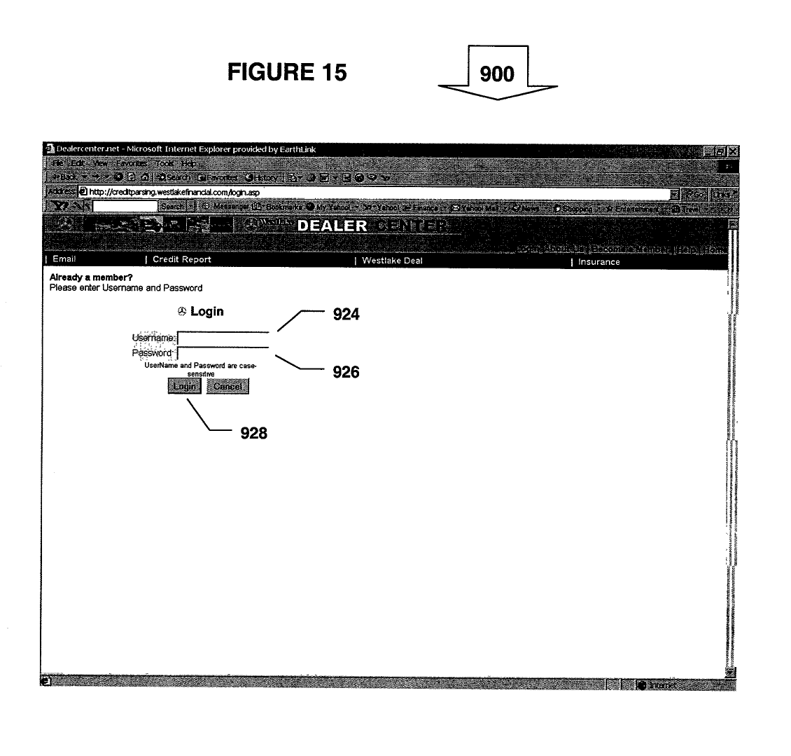

FIGS. 15 through 23 are exemplary embodiments of user interfaces depicting the DSS functionality. These various embodiments describe one specific way of practicing invention, displaying data or printing reports. However, one skilled in the art would recognize that there are multiple possible combinations of organizing the data, displaying the data on the screen as well as printing the data in various reporting formats which still express the same essential matter and process steps. The computer code detailing the functionality of the web site and credit guidelines associated in the decision making process is attached hereto in Appendix-B.

FIG. 15 is an exemplary embodiment of a home page 900 welcoming the user to the business entity's web site. By selecting a hypertext link for sign-up from the dealer center, the user accesses the sign up segment of the web site to sign up with the business entity to conduct the business. FIGS. 1, 6, 7, 12, and 14 above describe the business process in detail. From home page 900, the user is prompted to enter a user identification (i.e. Login Name) 924 and a password 926 associated with the user identification. Once the user submits the data by pressing a login button 928, DSS 40 authenticates the user before providing access. DSS 40 is a secured system. There is often a specific security on a document-by-document basis. The site in the present embodiment can be utilized as an intranet as well as across various networks over the Internet. In other embodiment, the password utilized by the DSS is case sensitive and requires that it be matched completely before the user is provided access to the system.

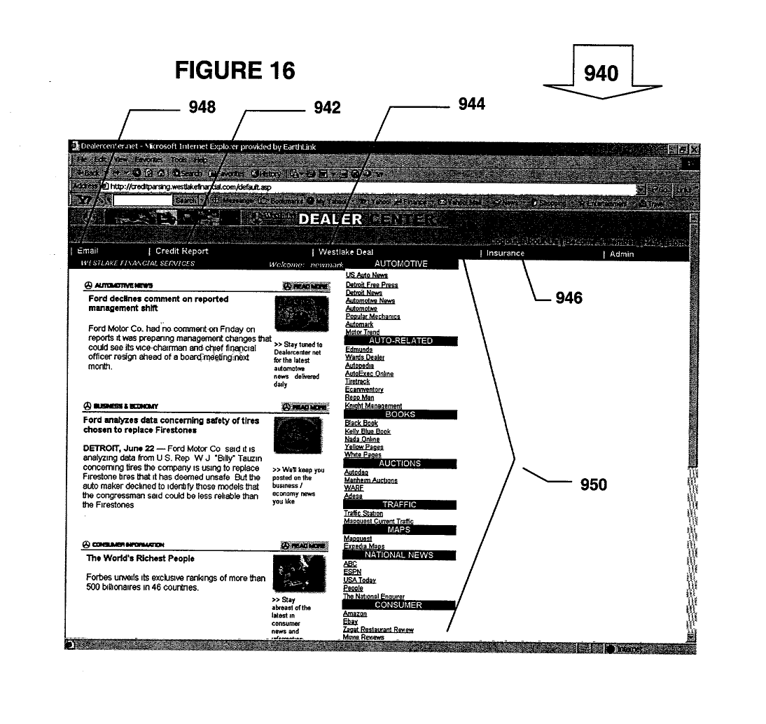

FIG. 16 is an exemplary embodiment of a user interface 940 providing information to a user regarding a specific loan transaction. User interface 940 is downloaded by server system 42 (shown in FIG. 2) on to client system 44 (shown in FIG. 2) when the user selects a specific transaction. From user interface 940, the dealer is able to go to Credit Reports 942 or Work a Deal 944. The dealer may also access an option to obtain an Insurance 946 or access an e-mail option 948. User interface 940 further provides additional information on Automotive, Auctions, Books, Traffic, Maps, and other Consumer Information.

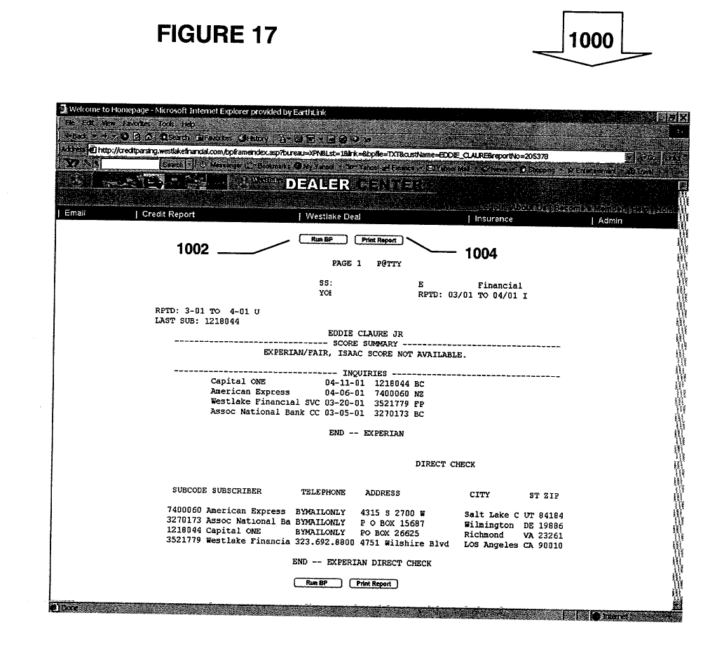

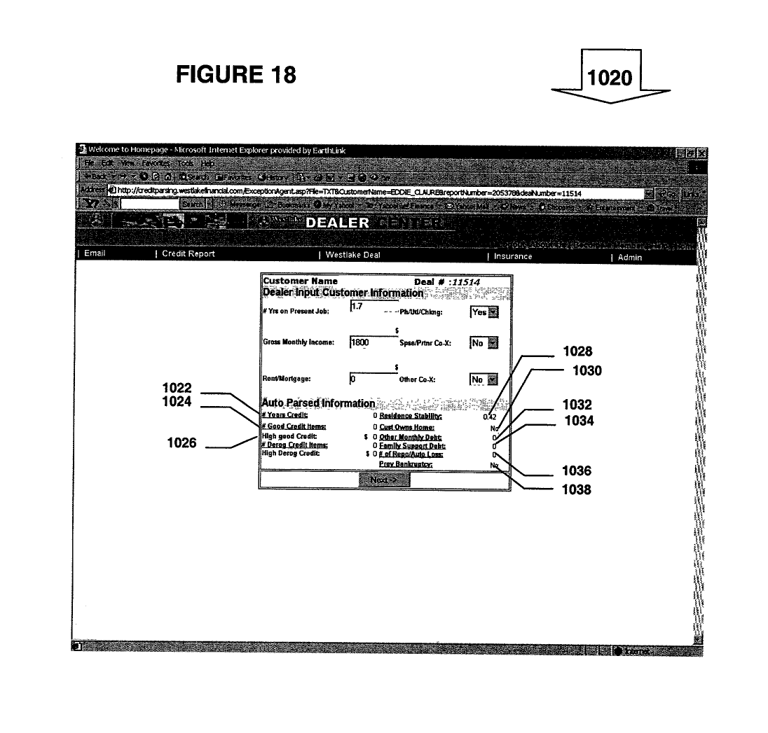

FIG. 17 is an exemplary embodiment of a Credit Report user interface 1000 providing the information to the user regarding a specific buyer. User interface 1000 provides the user with an option to “Run BP” 1002 or an option to “Print Report” 1004. Run BP 1002 option executes the program instructions to retrieve and execute the computer program stored in the memory. Upon execution of the Run BP 1002 option, the buyer's credit information is downloaded by server system 42 (shown in FIG. 2) on to client system 44 (shown in FIG. 2). The buyer's credit information is downloaded and directly transferred to a Customer Information user interface (shown in FIG. 18 below).

FIG. 18 is an exemplary embodiment of a Customer Information user interface 1020 providing information to the user regarding the buyer's credit. Customer Information user interface 1020 is downloaded by server system 42 (shown in FIG. 2) on to client system 44 (shown in FIG. 2) when the user selects “Run BP” option 1002 (shown in FIG. 17). Customer Information user interface 1020 is the first screen of the “BUY PROGRAM” with parsed customer information from the credit report, calculated and then “scored”. The “BUY PROGRAM” is a software program that resides on the server system and is executable by the user. The customer information is loaded into the fields necessary to calculate the deal from a “buy program template” that resides on the server. The Customer Information user interface 1020 displays various hypertext links, including, but not limited to, a # Years Credit 1022, a # Good Credit Items 1024, a # Derog Credit Items 1026, a Residence Stability 1028, a Cust Owns Home 1030, Other Monthly Debts 1032, Family Support Debts 1034, a # of Repo/Auto Loans 1036, and Previous Bankruptcy 1038. Selecting any of the hypertext link opens up a separate dialog box, which is then used by the user to “edit” the information and generate a “change report” to the deal file. The deal file is stored on the server system.

In an exemplary embodiment, the business entity runs the credit report from the bureau. The credit bureau sends the information back as a text file, or also in a packed record format. Each credit bureau agency uses a set of “tokens,” each of which is unique and identifies different variables on the credit report. For example, each possible account status (i.e., CURR ACCT, CHARGE OFF) is represented by one unique token. The parsing segment of the computer program reads the account status from the credit bureau and determines if the account is good, bad, or has no effect per the guidelines established by the business entity. The computer program also determines if there is a bankruptcy filing, or if an account is or might be an auto loan. The business entity also institutes customized rules and credit guidelines to evaluate the credit report accurately, since the credit bureau may have conflicting information. Based on the experience of the management personnel of the business entity, the parsing segment of the computer program is constantly revised to ensure accuracy as well credibility of the analysis. The on-going modification to the program to enable accurate scoring, and the revisions of the credit guidelines help assure correct conclusions pertaining to buyer's creditworthiness and help reduce risk to the business entity. The process further assures consistency in lending practices.

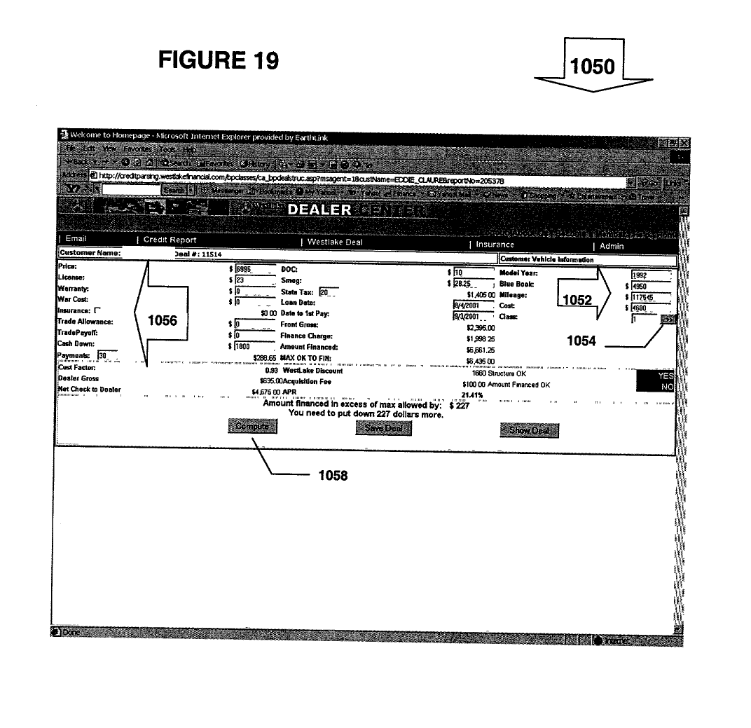

FIG. 19 is an exemplary embodiment of a Deal Calculation user interface 1050 providing the information to the user regarding the buyer's credit. Deal Calculation user interface 1050 is downloaded by server system 42 (shown in FIG. 2) on to client system 44 (shown in FIG. 2). Deal Calculation user interface 1050 is utilized by the user to input the information on a specific vehicle through a Customer Vehicle Information section 1052 and to finalize the deal structure. Customer Vehicle Information section 1052 requires information on the Model Year, the Blue Book value of the car, the Mileage of the car, the Cost of the car, and the Class Code. The Class code database is selectable and is obtained by selecting a button 1054 next to the Class. The Class code displays a list of vehicles and a “drill down” option to obtain relevant information to determine the specific class.

Deal Calculation user interface 1050 further provides identified fields to the user to fill out the deal structure information. Deal Structure information 1056 submitted by the user includes, but is not limited to, Price, Down Payment, Term of Deal, appropriate Taxes, license fees, documentary fees, smog fees, number of days to Is first payment, length of contract, etc. Once the user has completed all the information, the user selects a Compute button 1058. The results pertaining to the deal are then displayed on Deal Calculation user interface 1050. In an exemplary embodiment, the results displayed are YES/NO because the amount financed is more than the allowable amount financed. Under this scenario, the user determines the best way to re-work the deal to achieve the YES/YES result, either by obtaining more down payment or reducing the price. The credit guidelines discussed earlier, that are preloaded on to server system 42, are taken into consideration in evaluating the decision.

The dealer can also adjust or alter the deal to get a lower discount in any number of ways. The dealer can obtain more down payment, reduce the term of the contract, reduce the amount financed through the lower selling price or the dealer could “upgrade” the Class of the vehicle being sold.

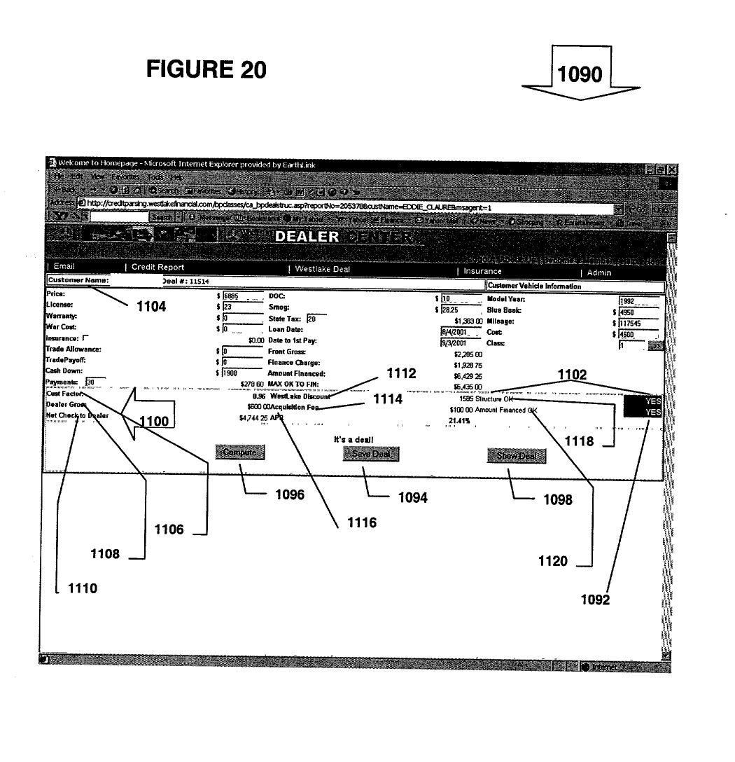

FIG. 20 is an exemplary embodiment of a Deal Calculation user interface 1090 indicating to the user that the deal is now approved. The approval is indicated by displaying “YES/YES” 1092 on the left hand corner of Deal Calculation user interface 1090. The result indicated in FIG. 20 is obtained by the dealer by increasing the down payment from $1,800 (shown in FIG. 19) to $1,900 (shown in FIG. 20) and reducing the price from $6,995 (shown in FIG. 19) to $6,885 (shown in FIG. 20). Through user interface 1090, the user then either saves the information by selecting a “Save Deal” button 1094, selects a “Compute” button 1096 for re-computing the entire deal with the new changes made on the user interface, or selects a “Show Deal” button 1098 to display and work another deal that was previously stored in DSS 40. Once the user transmits the request to compute the results, server system 42 (shown in FIG. 2) executes the instructions. The results are calculated and displayed under Calculation Results Section 1100, including a final summary regarding deal approval in Deal Approval Section 1102. Other information such as a customer's name (i.e. buyer's name) 1104, a Customer Factor 1106, a Dealer Gross 1108, a Net Check to Dealer 1110, a West Lake Discount 1112, an Acquisition Fee 1114, and an APR 1116 relating to the deal are also displayed on user interface 1090. Deal Approval Section 1102 displays a status of the Deal Structure 1118 by indicating either a “YES” or a “NO” and an Amount Financed 1120 by also indicating either a “YES” or a “NO” Save Deal 1094 saves the data entry and closes the deal data in the system.

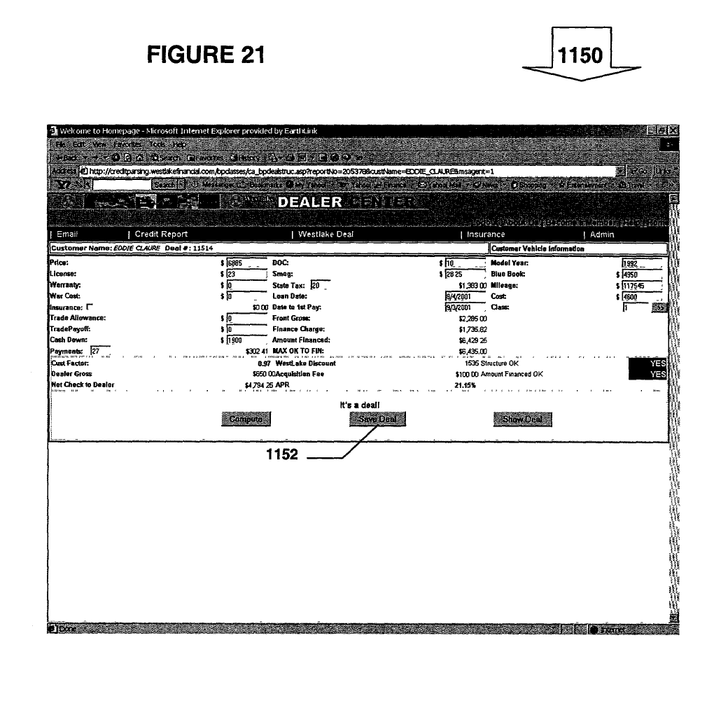

FIG. 21 is yet another exemplary embodiment of a Deal Calculation user interface 1150 indicating to the user that the deal is now approved. User interface 1150 is essentially the same deal with a shorter term of financing with the reduced dealer discount. As shown in user interface 1150, when the number of payments was reduced from 30 (shown in FIG. 20) to 27 (shown in FIG. 21), the dealer discount provided by the business entity was also reduced from $1,585 (shown in FIG. 21) to $1,535 (shown in FIG. 21). After the user has completed the deal structure, the user can save the deal by selecting a “Save Deal” button 1152 shown on user interface 1150.

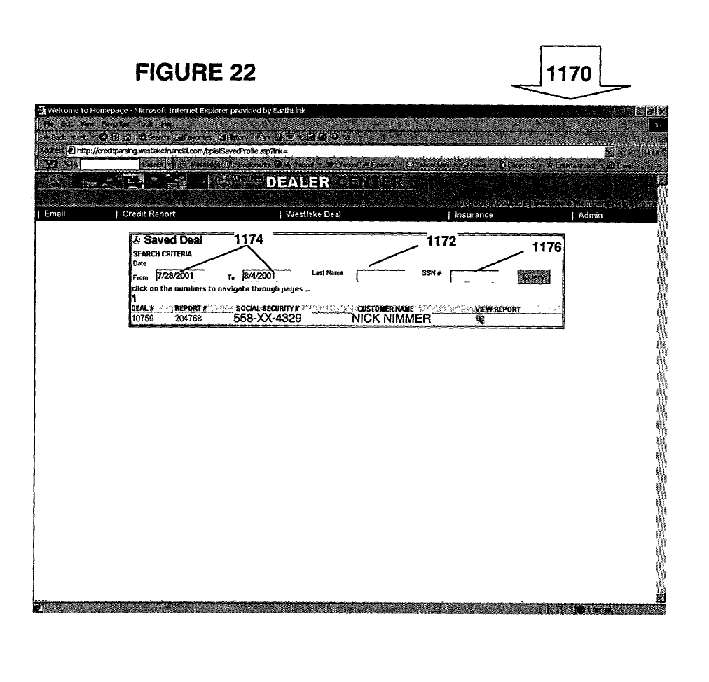

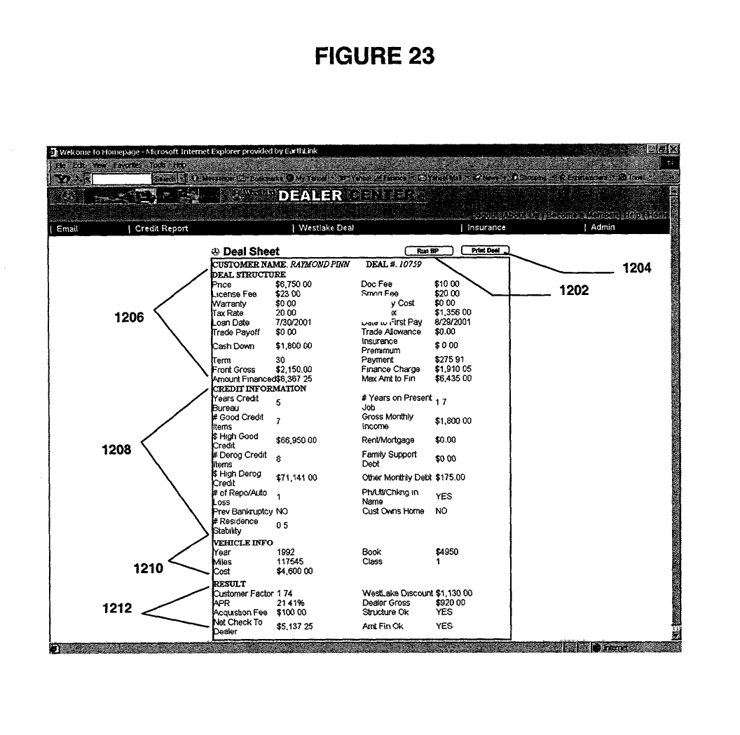

FIG. 22 is an exemplary embodiment of a Saved Deal user interface 1170. User interface 1170 is recalled on to client system 14 (shown in FIG. 2) from various deals previously saved by the dealer (user). The user utilizes various search criteria such as search by a customer name 1172, a date range 1174, or a social security number 1176. Once the results are displayed on client system 44, the user selects a specific customer name, or a specific deal under the customer name. Once the specific deal is selected, server system 42 (shown in FIG. 2) retrieves the deal from database 50 (shown in FIG. 2) and displays the deal information through a Deal Structure user interface 1200 (shown in FIG. 23, below) with all of the parameters and bureau parsed information.

FIG. 23 is an exemplary embodiment of Deal Structure user interface 1200 with all of the parameters and credit bureau parsed information. Recalled deal structure information is either printed by selecting a “Print Deal” button 1202 or reworked by utilizing a “Run BP” button 1204. The recalled Deal Structure user interface 1200 displays previously stored information about the deal including, but not limited to, Deal Structure Information 1206, Credit Information 1208, Vehicle Information 1210 and Results Information 1212.

While the invention has been described in terms of various specific embodiments, those skilled in the art will recognize that the invention can be practiced with modification within the spirit and scope of the claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for structuring a deal by a dealer, using a network based system including a server system coupled to a centralized database and at least one client system, said method comprising:
receiving a loan application from a buyer regarding the deal and running a credit report based on the loan application;
analyzing the credit report to evaluate the buyer's creditworthiness in relationship to the deal; and
structuring the deal by the server system based on the buyer's creditworthiness and pre-determined credit criteria.

2. A method according to claim 1 wherein said step of receiving a loan application further comprises the step of receiving at least one of a social security number of the buyer, a date of birth of the buyer, a driver's license number of the buyer, an expiration date of the buyer's driver license number, a name of the nearest relative of the buyer, a name of the current landlord of the buyer, gross monthly income of the buyer, rent presently paid by the buyer, a mortgage amount per month paid by the buyer, other monthly debts of the buyer, residence stability information since age eighteen, and a number of years on the present job.

3. A method according to claim 1 wherein said step of receiving a loan application further comprises the step of receiving at least one of a model year of a vehicle, blue book value of the vehicle, a current mileage on the vehicle, a class of the vehicle, a cost of the vehicle, FR Gross, and a warranty cost on the vehicle.

4. A method according to claim 1 wherein said step of analyzing the credit report further comprises the step of scoring the credit report.

5. A method according to claim 4 wherein said step of scoring further comprises the step of scoring at least one of a number of years of established credit, a number of good credit items, a dollar amount related to a highest credit ever granted to the buyer by an institution, a number of derog credit items, a highest dollar amount ever established as a derog credit, a number of repossessions, a number of previous bankruptcies, a residence stability index, a number of years on the present job, gross monthly income, rent and mortgage amount per month, and other monthly debts.

6. A method according to claim 4 wherein said step of scoring further comprises the steps of:
determining whether the buyer has at least one of a telephone bill, a utility bill and a checking account, in the buyer's name;
determining whether the buyer's spouse has co-signed the loan application; and
determining whether there is another co-signer in addition to buyer's spouse.

7. A method according to claim 4 wherein said step of scoring further comprises the steps of:
downloading at least one of a number of years of established credit, a number of good credit items, a dollar amount related to the highest credit ever granted to the buyer by an institution, a number of derog credit items, a highest dollar amount ever established as a derog credit, a number of repossessions, a number of previous bankruptcies, a residence stability index, a number of years on the present job, gross monthly income, rent and mortgage amount per month, and other monthly debts;
downloading a response to at least one of a question a) whether the buyer has at least one of a phone bill, a utility bill and a checking account, in the buyer's name; b) whether the buyer's spouse has cosigned the loan application, c) whether there is another cosigner in addition to buyer's spouse.

8. A method according to claim 7 wherein said steps of downloading further comprise the steps of:
accessing the centralized database;
searching the centralized database to obtain the buyer's information based on the buyer's loan application and the credit report;
retrieving information from the centralized database; and
transmitting the retrieved information to the client system for display by the client system.

9. A method according to claim 7 wherein said step of structuring the deal by the server system further comprises the step of adjusting the deal based on at least one of a down payment, a price of the deal, a term of the deal, other related costs, an amount financed, a class, and a dealer discount.

10. A method according to claim 7 wherein said step of structuring the deal by the server system further comprises the step of providing guidance to the dealer utilizing a cartoon character based on the pre-determined credit criteria to adjust at least one of a down payment, a price of the deal, a term of the deal, other related costs, an amount financed, a class, and a dealer discount.

11. A method according to claim 1 further comprising the steps of:
reviewing the loan application and the credit report of the buyer;
auditing underlying documents in compliance with local, state, and federal guidelines for funding the deal; and
issuing a check to the dealer pursuant to legal agreements to fund the deal.

12. The method according to claim 1 wherein the client system and the server system are connected via a network and wherein the network is one of a wide area network, a local area network, an intranet and the Internet.

13. A system for managing dealer transactions in compliance with federal and state regulations, said system comprising:
a client system comprising a browser;
a data storage for storing information;
at least one server system configured to be coupled via a network to said client system and said data storage device, said server system further configured to:
provide an access to a dealer after the dealer has been authenticated;
run a credit report on a buyer based on the buyer's loan application;
receive additional information from the dealer about the deal after the buyer information has been automatically transferred to a deal structure user interface; and
approve the deal based on pre-determined credit criteria, and if the deal cannot be approved, provide guidance to the dealer utilizing a cartoon character based on the pre-determined credit criteria to adjust the deal structure parameters.

14. A system according to claim 13 wherein said client system is further configured with:
a displaying component for displaying a variety of options to a user; and
a sending component to send an inquiry to the server system so that the server system can process and download the requested information to the client system.

15. A system according to claim 14 wherein the sending component functions in response to a click of a mouse button.

16. A system according to claim 14 wherein the sending component functions in response to a voice command.

17. A system according to claim 13 wherein said client system is further configured to be protected from access by unauthorized individuals.

18. A system according to claim 13 wherein said server system is configured to send automatic e-mail notifications to parties involved.

19. A computer to facilitate online processing and approval of deals, said computer coupled to a centralized database and programmed to:
receive deal information in to the centralized database;
store the deal information into various subsections of the centralized database and cross reference the deal information against a dealer identification for easy retrieval and update;
evaluate the deal based on pre-determined credit criteria; and
provide guidance to the dealer to adjust the deal based on pre-determined underwriting criteria and approve the deal after the dealer has made changes based on the provided guidance; and
generate management reports to track the deal status.

20. The computer according to claim 19 further programmed to provide a notification to users via electronic mail regarding final decision.

21. The computer according to claim 19 further programmed to provide flexibility to an administrator to make changes to the centralized database by at least one of adding, modifying and deleting the deal information.

22. The computer according to claim 19 wherein the deal information comprises at least one of:
a) a number of years of established credit,
b) a number of good credit items,
c) a dollar amount related to a highest credit ever granted to the buyer by an institution,
d) a number of derog credit items,
e) a highest dollar amount ever established as a derog credit,
f) a number of repossessions or auto leases,
g) a number of previous bankruptcies,
h) a residence stability index,
i) a number of years on a present job,
j) gross monthly income,
k) rent and mortgage amount per month,
l) other monthly debts,
m) a response to a question whether the buyer has at least one of a phone bill, a utility bill and a checking account, in the buyer's name,
n) a response to a question whether the buyer's spouse has cosigned the loan application,
o) a response to a question whether there is another cosigner in addition to the buyer's spouse
p) a model year of the vehicle,
q) blue book value of the vehicle,
r) current mileage on the vehicle,
s) a class of the vehicle,
t) a cost of the vehicle,
u) FR Gross, and
v) a warranty cost on the vehicle.

23. The computer according to claim 19 further programmed to download at least one of a home page user interface, credit report user interface, a customer information user interface, deal calculation user interface and a deal structure user interface.

24. A computer program embodied on a computer readable medium for processing and approving deals based on pre-defined risk guidelines, comprising a code segment that:
receives a deal from the dealer;
evaluates the deal based on the pre-defined risk guidelines, and
provides a decision to the dealer of at least one of approving and rejecting the deal after the underlying documents are audited to ensure compliance with state and federal regulations.

25. The computer program as recited in claim 24 further includes a code segment that evaluates the deal utilizing at least one of a term, an advance, and a discount.

26. The computer program as recited in claim 24 wherein the term is determined by at least one of a year of the vehicle, mileage, and a Class combined with a Customer Factor.

27. The computer program as recited in claim 24 wherein the advance allowed is determined by at least one of a Wholesale Kelley Bluebook value, a NADA Trade Value, mileage, and a Class of the vehicle.

28. The computer program as recited in claim 24 wherein the discount is determined by utilizing at least one of a Payment Probability Model, a Minimum Discount Model to determine minimum discounts for a certain sets of input, and an Extra Term Model.

29. The computer program as recited in claim 24 further includes a code segment that generates various management reports based on the dealer selected criteria in a pre-determined format to track dealer transactions.

30. The computer program as recited in claim 24 further includes a code segment that monitors the security by restricting access to unauthorized individuals.

31. A database to manage dealer transactions and facilitate deal structuring for dealers, said database comprising:
data corresponding to at least one of Dealers Information, Vehicle Information, Dealer Transactions, Buyers Information, and Credit Guidelines; wherein the data corresponding to at least one of Dealers Information and Dealer Transactions is cross referenced to data corresponding Buyers Information.

32. A database according to claim 31 further comprising data corresponding to at least one of dealers across the United States, Various vehicles information, Class codes, Class types indicating at least one of Domestic and Imported type, Blue book values, Buyer's contact information, Credit report information pertaining to each buyer, and Various credit guidelines.

33. A database according to claim 31 further comprising data corresponding to dealers preferences for products and services.

34. A database according to claim 31 further comprising data corresponding to dealers performance metrics.

35. A database according to claim 31 further comprising data corresponding to buyers preferences for products and services.

36. A database according to claim 31 further comprising data corresponding to negative history of at least one of dealers and buyers.

37. A database according to claim 31, wherein data corresponding to at least one of Dealers Information, Vehicle Information, Dealer Transactions, Buyers Information, and Credit Guidelines is further divided into several individualized sub-sections to store data in various different categories.

38. A method for structuring a deal by a dealer for a buyer, using a network based system including a server system coupled to a centralized database and at least one client system, said method comprising:
accepting deal data from the client system and running a credit report based on the deal data;
determining the buyer's credit worthiness by scoring the credit report based on pre-determined credit guidelines stored on the server system;
providing the response to the client system based on at least one of deal data and the buyer's credit worthiness; and
structuring the deal based on the deal data.

39. A method according to claim 38 wherein said steps of providing the response to the client system further comprises the steps of:
providing at least one of a YES/YES, a YES/NO, a NO/YES, and a NO/NO response from the server system; and
providing guidance to the dealer utilizing a cartoon character based on the pre-determined credit criteria to adjust at least one of a down payment, a price of the deal, a term of the deal, other related costs, an amount financed, a class, and a dealer discount to obtain a YES/YES response from the server system.

40. A method according to claim 39 wherein the response YES/YES refers to an approval of the deal structured and an approval of amount financed by the dealer.

41. A method according to claim 39 wherein the response YES/NO refers to an approval of the deal structured and a rejection of amount financed by the dealer.

42. A method according to claim 39 wherein the response NO/YES refers to a rejection of the deal structured and an approval of amount financed by the dealer.

43. A method according to claim 39 wherein the response NO/NO refers to a rejection of the deal structured and a rejection of amount financed by the dealer.

44. A method according to claim 38 further comprising the steps of:
reviewing the loan application and the credit report of the buyer;
auditing underlying documents in compliance with local, state, and federal guidelines for funding the deal; and
issuing a check to the dealer pursuant to legal agreements to fund the deal.

45. The method according to claim 38 wherein the client system and the server system are connected via a network and wherein the network is one of a wide area network, a local area network, an intranet and the Internet.
